(19) United States
(12) Patent Application Publication
(10) Pub. No.: US 2020/0296266 A1
(43) Pub. Date: Sep. 17, 2020

(54) MOVABLE BODY

(71) Applicant: CANON KABUSHIKI KAISHA, Tokyo (JP)

(72) Inventors: Yasushi Koyama, Kamakura-shi (JP); Takahiro Sato, Ebina-shi (JP); Takeaki Itsuji, Hiratsuka-shi (JP); Toshifumi Yoshioka, Hiratsuka-shi (JP); Eiichi Takami, Chigasaki-shi (JP); Noriyuki Kaifu, Atsugi-shi (JP); Jun Iba, Yokohama-shi (JP); Rei Kurashima, Yokohama-shi (JP)

(21) Appl. No.: 16/815,171

(22) Filed: Mar. 11, 2020

(30) Foreign Application Priority Data
Mar. 14, 2019 (JP) 2019-047787
Feb. 27, 2020 (JP) 2020-032189

(51) Int. Cl. H04N 5/225; H04N 5/247; B61D 1/00; B61D 49/00

(52) U.S. Cl. CPC H04N 5/2256; H04N 5/2258; B61D 49/00; B61D 1/00; H04N 5/247

(57) ABSTRACT

A movable body includes an imaging system which acquires an image formed by a terahertz wave, wherein the image is an image obtained by capturing an inspection object inside the movable body.

### BACKGROUND OF THE INVENTION

### Field of the Invention

The present invention relates to a movable body including an imaging system.

### Description of the Related Art

An inspection technique using a terahertz wave is known. The terahertz wave can be defined as an electromagnetic wave having a frequency of 30 GHz (inclusive) to 30 THz (inclusive). Japanese Patent Laid-Open No. 2004-286716 discloses a method of inspecting a prohibited drug such as a narcotic drug enclosed in a sealed letter. In this method, a characteristic absorption spectrum that a prohibited drug such as a narcotic drug has in the terahertz band is used to identify a substance in a sealed letter without breaking the seal.

Recently, a dangerous item such as a knife which is taken into a movable body is a serious problem from the viewpoint of crime prevention. There is strong demand for a technique of detecting such a dangerous item in a movable body, but no such technique has been implemented.

The present invention provides a technique advantageous for crime prevention in a movable body.

### SUMMARY OF THE INVENTION

A movable body according to one aspect of the present invention comprises an imaging system configured to acquire an image formed by a terahertz wave. The imaging system can be arranged to capture an inspection object inside the movable body.

One of aspects of the present invention provides a movable body comprising an imaging system configured to acquire an image formed by a terahertz wave, wherein the image is an image obtained by capturing an inspection object inside the movable body.

Further features of the present invention will become apparent from the following description of exemplary embodiments with reference to the attached drawings.

### BRIEF DESCRIPTION OF THE DRAWINGS

FIGS. 1A to 1C are views each showing a coach according to the embodiment;

FIG. 2 is a view schematically showing a state in which a coach of the first arrangement example has stopped at a platform in a station;

FIG. 3 is a view schematically showing a state in which a coach of the second arrangement example has stopped at a platform in a station;

FIG. 4 is a view showing a more detailed example of the second arrangement example;

FIGS. 5A and 5B are views schematically showing arrangement examples of a plurality of illumination sources and a plurality of cameras;

FIG. 6 is a view schematically showing a coach of the third arrangement example;

FIG. 7 is a view schematically showing a coach of the fourth arrangement example;

FIG. 8 is a view schematically showing a coach of the fifth arrangement example;

FIG. 9 is a view schematically showing a coach of the sixth arrangement example;

FIG. 10 is a view schematically showing a coach of the seventh arrangement example;

FIG. 11 is a view schematically showing a coach of the eighth arrangement example;

FIG. 12 is a view schematically showing a coach of the eighth arrangement example;

FIG. 13 is a block diagram showing the arrangement of a coach and the arrangement of a station monitoring system;

FIGS. 14A and 14B are views showing an arrangement example of a ticket gate machine in which an imaging system included in a camera system according to an embodiment is arranged;

FIGS. 15A and 15B are views showing a modification of the ticket gate machine shown in FIGS. 14A and 14B;

FIGS. 16A and 16B are views showing an arrangement example of a partition in which the imaging system included in the camera system according to the embodiment is arranged;

FIGS. 17A to 17C are views showing a modification of the partition shown in FIGS. 16A and 16B;

FIGS. 18A and 18B are views showing an arrangement example of an escalator in which the imaging system included in the camera system according to the embodiment is arranged;

FIGS. 19A and 19B are views showing an arrangement example of a staircase in which the imaging system included in the camera system according to the embodiment is arranged;

FIGS. 20A and 20B are views showing an arrangement example of a passage in which the imaging system included in the camera system according to the embodiment is arranged;

FIG. 21 is a view showing an arrangement example of a station in which the imaging system included in the camera system according to the embodiment is arranged;

FIG. 22 is a view showing an arrangement example when the camera system according to the embodiment and a railroad coach monitor an inspection object;

FIG. 23 is a conceptual view of a processing system according to the first embodiment;

FIG. 24 is a flowchart of processing according to the first embodiment;

FIG. 25 is a conceptual view of a processing system according to the second embodiment;

FIG. 26 is a flowchart of processing according to the second embodiment;

FIG. 27 is a conceptual view of a processing system according to the third embodiment;

FIG. 28 is a flowchart of processing according to the third embodiment;

FIG. 29 is a conceptual view of a processing system according to the fourth embodiment;

FIG. 30 is a conceptual view of a processing system according to the fifth embodiment;

FIG. 31 is a view showing an arrangement example of the processing system;

FIG. 32 is a view showing an arrangement example of the processing system;

FIG. 33 is a flowchart showing an operation example of the camera system according to the embodiment;

FIG. 34 is a flowchart showing an operation example of the camera system according to the embodiment;

FIG. 35 is a flowchart showing an operation example of the camera system according to the embodiment; and

FIG. 36 is a flowchart showing an operation example of the camera system according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In the specification, “embodiment” may be an embodiment of the invention described in the appended claims, or may be an embodiment of an invention that is not described in the appended claims.

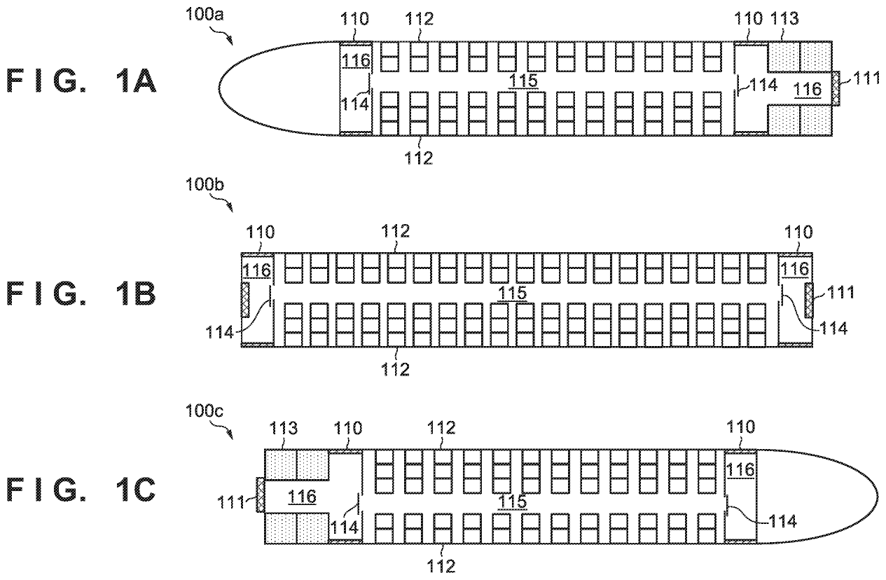

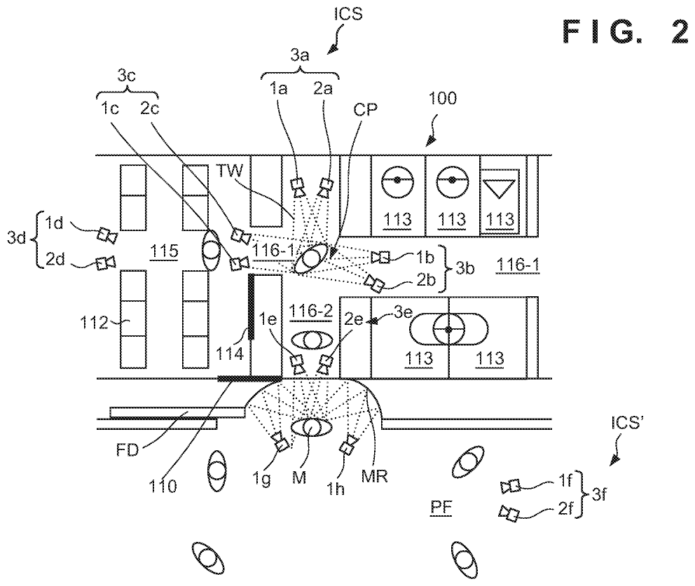

FIGS. 1A to 1C exemplarily show coaches 100a, 100b, and 100c according to the embodiment, respectively. The coaches 100a, 100b, and 100c can be railroad coaches but may be buses. In one example, a train can be formed by connecting one coach 100a, one or a plurality of coaches 100b, and one coach 100c. The coaches 100a, 100b, and 100c will be referred to as coaches 100 if they are explained without being distinguished from each other.

The coach 100 can include, for example, a side door (side-sliding door) 110, a pass-through door 111, a seat 112, a facility 113, a partition door 114, a cabin aisle 115, and a deck 116. The side door 110, the pass-through door 111, and the partition door 114 are doors. In this specification, to identify the doors from each other, unique names are given according to conventions. The side door 110 is a door arranged between the inside and the outside of the coach 100. The pass-through door 111 is a door arranged at one or both of the two end portions of the coach 100. The seat 112 can be used as, for example, a non-reserved seat or a reserved seat. The facility 113 can include, for example, a wash stand, a rest room, a smoking room, and the like. The partition door 114 is a door arranged between the deck 116 and the cabin (in other words, the cabin aisle 115) in which a plurality of seats 112 are arranged. The cabin aisle 115 is an aisle provided in the cabin so as to pass by a side of the space where the plurality of seats 112 are arranged. The cabin aisle 115 can be arranged, for example, between a first seat row formed by a plurality of first seats and a second seat row formed by a plurality of second seats. The deck 116 is an aisle partitioned by, for example, the partition door 114, the pass-through door 111, and the side door 110. Note that a coach will be described here as an example. However, this technique can be applied to a movable body (automobile (standard-size vehicle, bus, and truck), airplane, helicopter, and ship) that carries persons or goods.

FIG. 2 schematically shows a state in which the coach 100 of the first arrangement example has stopped at a platform PF in a station. The platform PF can include a platform screen door FD. The coach 100 can include an imaging system ICS configured to acquire an image formed by a terahertz wave TW. The imaging system ICS can be arranged to capture the inspection object M that uses a common-use portion of the coach 100, which is the interior of the movable body. The common-use portion is a place or a space usable by many unspecified persons. The inspection object M is normally a person but may be an animal other than a person or a robot.

An imaging system ICS′ can also be arranged on the platform PF. The imaging system ICS can include one or a plurality of imaging units 3a, 3b, 3c, 3d, and 3e. The imaging system ICS′ can include one or a plurality of imaging units 3f. The imaging units 3a, 3b, 3c, 3d, 3e, and 3f will be referred to as an imaging units 3 if they are explained without being distinguished from each other. A terahertz wave passes through a fabric, a leather, a chemical fiber, a resin, and the like. For this reason, a processor (not shown) connected to the imaging system ICS can detect a dangerous item such as a firearm, a cutting tool, or an explosive based on an image provided from the imaging system ICS.

The imaging unit 3 may be a passive type imaging unit, or may be an active type imaging unit. In the passive type imaging unit 3, an image formed on the imaging plane of the imaging unit by the terahertz wave TW radiated from the peripheral environment or the inspection object M is acquired, that is, captured as an electrical image by the imaging unit without illuminating the inspection object M with the terahertz wave TW. The active type imaging unit 3 can include an illumination source 1 and a camera 2. In the example shown in FIG. 2, the imaging system ICS includes the plurality of imaging units 3a, 3b, 3c, 3d, and 3e formed by a plurality of illumination sources 1a, 1b, 1c, 1d, and 1e and a plurality of cameras 2a, 2b, 2c, 2d and 2e. In addition, the imaging system ICS′ includes the imaging unit 3f formed by an illumination source if and a camera 2f. The plurality of illumination sources 1a, 1b, . . . will be referred to as the illumination sources 1 if they are explained without being distinguished from each other, and the plurality of cameras 2a, 2b, . . . will be referred to as the cameras 2 if they are explained without being distinguished from each other.

The plurality of cameras 2 can be arranged such that their optical axes face directions different from each other. The illumination source 1 radiates the terahertz wave TW, and the inspection object M can be illuminated with the terahertz wave TW. The camera 2 acquires, that is, captures, as an electrical image, an image formed on the imaging plane by the terahertz wave TW mainly specularly reflected by the inspection object M illuminated with the terahertz wave TW. The imaging system ICS may include a visible light camera that captures an image formed by visible light. Similarly, the imaging system ICS′ may include a visible light camera that captures an image formed by visible light.

The coach 100 can include a common-use portion. The common-use portion can include, for example, an aisle. The aisle can include, for example, the deck 116 and/or the cabin aisle 115. The deck 116 can include a first aisle 116-1 extending in the first direction (the horizontal direction in FIG. 2), and a second aisle 116-2 extending in the second direction (the vertical direction in FIG. 2) different from the first direction and connected to the first aisle 116-1. The first aisle 116-1 and the second aisle 116-2 may intersect, as shown in FIG. 2. The first aisle 116-1 and the cabin aisle 115 can be parallel to each other. The second aisle 116-2 and the cabin aisle 115 can be orthogonal to each other.

The inspection object M on the platform PF can get into the coach 100 via an opening portion formed as the side door 110 opens, move through the second aisle 116-2, and change the advancing direction to a direction facing the partition door 114 at a connecting portion CP between the first aisle 116-1 and the second aisle 116-2. After that, the inspection object M can enter the cabin aisle 115 via an opening portion formed as the partition door 114 opens. Alternatively, the inspection object M on the platform PF can get into the coach 100 via the opening portion formed as the side door 110 opens, move through the second aisle 116-2, and change the course to the direction of the first aisle 116-1 (the side of the facility 113) at the connecting portion CP. That is, the inspection object M can change the advancing direction at the connecting portion CP between the first aisle 116-1 and the second aisle 116-2. The connecting portion CP can be considered as a branch point or a corner where the inspection object M changes the advancing direction. That is, the connecting portion CP can be a position where the inspection object moving in the coach (movable body) makes a direction change, a position where the inspection object decelerates or stops, or a position where the inspection object rotates. Alternatively, the connecting portion CP can be a position where the inspection object moving in the coach (movable body) is rectified. Rectify here means that spreading lines of a plurality of inspection objects lining up on the platform are reduced when they enter the coach 100. Typically, the inspection objects are rectified into one or two lines in the coach 100.

When the imaging system ICS is arranged to capture the inspection object M at the connecting portion CP, the inspection object M can be captured from various directions in accordance with a change in the direction of the inspection object M. In addition, when the plurality of cameras 2 of the imaging system ICS are arranged to capture the inspection object M at the connecting portion CP, the inspection object M can further be captured from various directions/angles. This can improve the detection probability of the position/shape/material of a dangerous item by a processor connected to the imaging system ICS.

The first aisle 116-1 and the second aisle 116-2 may intersect at the connecting portion CP, an end portion of the first aisle 116-1 may end at the connecting portion CP, and an end portion of the second aisle 116-2 may end at the connecting portion CP. Alternatively, an end portion of the first aisle 116-1 and the second aisle 116-2 may end at the connecting portion CP. Furthermore, the cabin aisle 115 may be understood as the second aisle, and the second aisle and the first aisle 116-1 may be connected at the connecting portion CP. Another example of the connecting portion CP can include a connecting portion between a planar aisle serving as the first aisle and a staircase serving as the second aisle.

In the example shown in FIG. 2, the imaging system ICS includes imaging units 3a, 3b, and 3c that capture the inspection object M existing at the connecting portion CP. The imaging unit 3c can be arranged in the cabin to capture the inspection object M via an opening portion formed as the partition door 114 opens. Since the inspection object M normally is often stopped by instinct before the partition door 114, the imaging unit 3c is advantageous in capturing a number of images. The imaging unit 3d can be arranged to capture the inspection object M passing through the cabin aisle 115. The imaging units 3c and 3d can be arranged on all or some of the seat 112, a rack, a floor, and a ceiling. In particular, since the terahertz wave passes through a resin or the like, the imaging units 3c and 3d can easily be arranged in various places. Here, the degree of freedom of the arrangement of the imaging units 3c and 3d is higher on the floor and the ceiling then on the seat 112 whose position is fixed. Hence, the imaging units 3c and 3d can be arranged while being embedded in the floor and/or the ceiling.

In some airports, a body scanner using a millimeter wave is used. Since such a body scanner is extremely bulky and inspection therewith is time consuming, it is not realistic to apply this to a ground transportation system that transports an enormous number of people. In the example shown in FIG. 2, a compact imaging system or monitoring system can be provided.

The imaging unit 3e can be arranged in the cabin to capture the inspection object M via an opening portion formed as the side door 110 opens. Since the inspection object M normally often stops by instinct before the side door 110, the imaging unit 3e is advantageous in capturing a number of images. One or a plurality of illumination sources lg and lh configured to assist image capturing by the imaging unit 3e can be arranged on the platform PF. Also, a reflecting surface MR configured to assist image capturing by the imaging unit 3e can be arranged on the platform PF. The reflecting surface MR can include a curved surface. The reflecting surface MR may be provided on the coach 100. The reflecting surface MR can be formed by a metal surface. A film of coating or the like or a poster made of paper or the like may be provided on the metal surface. Alternatively, for example, the reflecting surface MR may be formed by a surface of a member made of a resin or the like having a surface roughness equal to or less than the wavelength of an electromagnetic wave to irradiate, preferably 1/10 or less of the wavelength, and typically on an order of 10 to 100 micrometers.

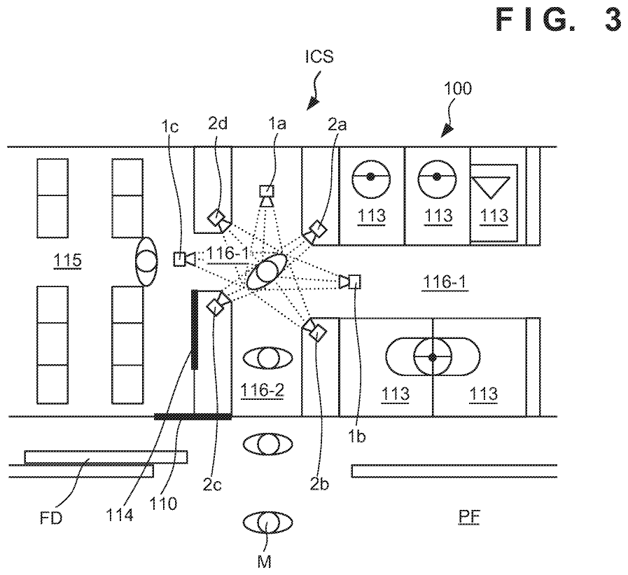

FIG. 3 schematically shows a state in which the coach 100 of the second arrangement example has stopped at the platform PF in a station. Matters that are not mentioned as the second arrangement example can comply with the first arrangement example. The imaging system ICS can include the plurality of illumination sources 1a, 1b, and 1c and the plurality of cameras 2a, 2b, 2c, and 2d. The number of the plurality of illumination sources 1a, 1b, and 1c and the number of the plurality of cameras 2a, 2b, 2c, and 2d may equal to each other, or may be different from each other. All or some of the plurality of cameras 2a, 2b, 2c, and 2d can be arranged at the corner portions of walls in the coach 100. Although not illustrated in FIG. 3, all or some of the plurality of illumination sources 1a, 1b, and 1c may be arranged at the corner portions of walls in the coach 100. All or some of the plurality of cameras 2a, 2b, 2c, and 2d may be arranged while being superposed in the vertical direction. All or some of the plurality of illumination sources 1a, 1b, and 1c may be arranged while being superposed in the vertical direction. The imaging system ICS may include the plurality of cameras 1a, 1b, and 1c and the plurality of illumination sources 2a, 2b, 2c, and 2d.

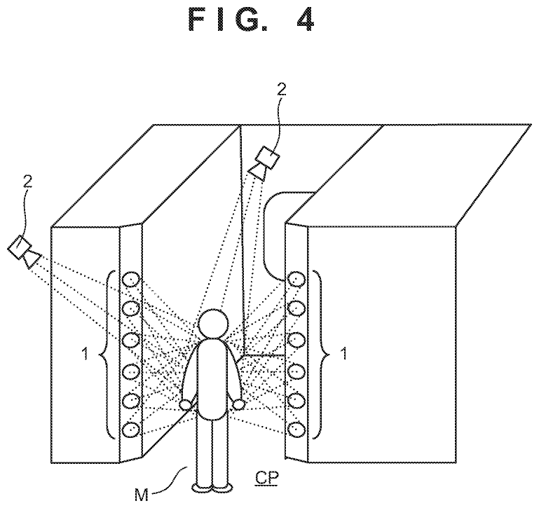

FIG. 4 shows a more detailed example of the second arrangement example. As shown in FIG. 4, one or a plurality of illumination sources 1 can be arranged at the corner portions of walls in the coach 100 while being superposed in the vertical direction. The corner portions can be the corner portions of walls facing the connecting portion CP. In addition, one or a plurality of cameras 2 can be arranged. The one or the plurality of cameras 2 may be arranged at the corner portions, or may be arranged on the ceiling or the floor. The illumination sources 1 and the cameras 2 can be embedded in structures such as a wall, a ceiling, and a floor so the inspection object M cannot visually recognize them.

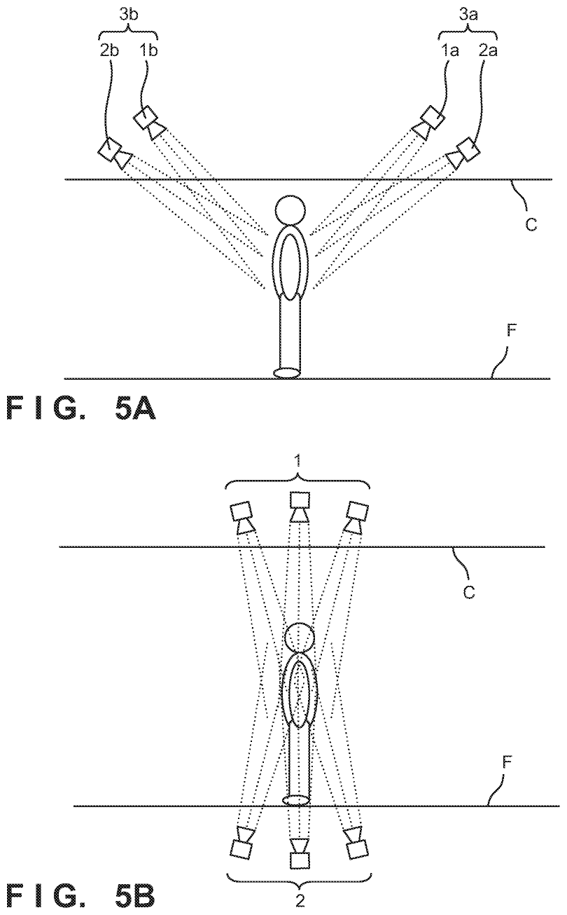

FIG. 5A schematically shows an arrangement example of the plurality of illumination sources 1a and 1b and the plurality of cameras 2a and 2b. As schematically shown in FIG. 5A, the plurality of illumination sources 1a and 1b and the plurality of cameras 2a and 2b can be arranged on a ceiling C. Here, the plurality of illumination sources 1a and 1b and the plurality of cameras 2a and 2b can be arranged while being embedded in the ceiling C.

FIG. 5B schematically shows another arrangement example of the plurality of illumination sources 1 and the plurality of cameras 2. As schematically shown in FIG. 5B, the plurality of illumination sources 1 can be arranged on the ceiling C, and the plurality of cameras 2 can be arranged on a floor F. Here, the plurality of illumination sources 1 can be arranged while being embedded in the ceiling C, and the plurality of cameras 2 can be arranged while being embedded in the floor F. To the contrary to this, the plurality of illumination sources 1 may be arranged on the floor F, and the plurality of cameras 2 may be arranged on the ceiling C. Here, the plurality of illumination sources 1 can be arranged while being embedded in the floor F, and the plurality of cameras 2 can be arranged while being embedded in the ceiling C.

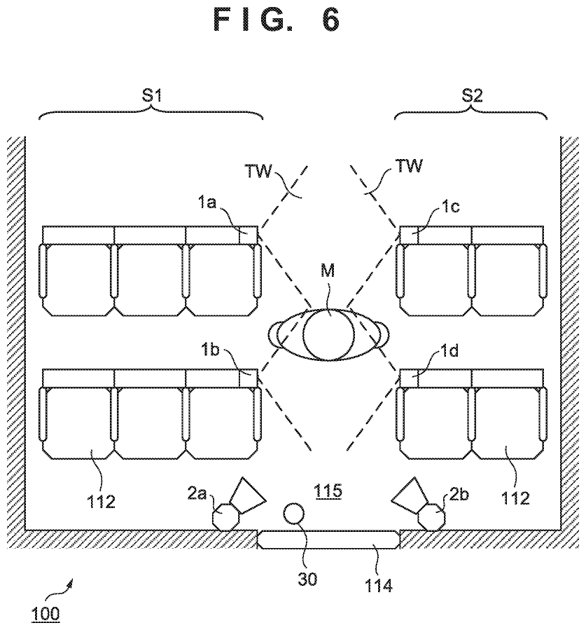

FIG. 6 schematically shows the coach 100 of the third arrangement example. Matters that are not mentioned as the third arrangement example can comply with the first or second arrangement example. The third arrangement example may be implemented in combination with at least one of the first and second arrangement examples. In the third arrangement example, the imaging system can include the plurality of illumination sources 1a to 1d arranged on the plurality of seats 112 to irradiate the inspection object M using the cabin aisle 115 as a common-use portion with the terahertz wave TW. Also, the imaging system can include the plurality of cameras 2a and 2b arranged on the periphery of the doorway (partition door 114) of the cabin to capture the inspection object M irradiated with the terahertz wave. The cabin aisle 115 can be arranged, for example, between a first seat row S1 formed by a plurality of first seats 112 and a second seat row S2 formed by a plurality of second seats 112. The plurality of illumination sources 1a to 1d can be arranged on the seats 112 facing the cabin aisle 115.

The coach 100 can include a sensor 30 configured to detect the inspection object M. The plurality of illumination sources 1a to 1d can be controlled based on the output of the sensor 30. For example, the plurality of illumination sources 1a to 1d can be controlled to radiate the terahertz wave TW in response to detection of the inspection object M by the sensor 30. The sensor 30 may also serve as a sensor configured to detect the approach of the inspection object M and open the partition door 114.

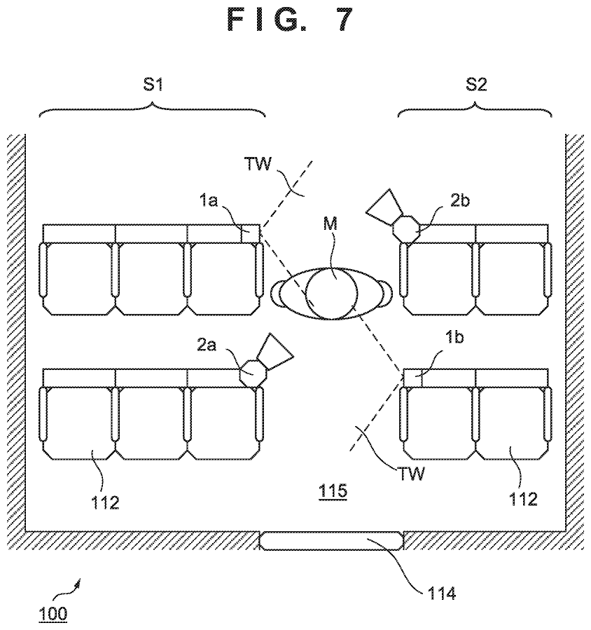

FIG. 7 schematically shows the coach 100 of the fourth arrangement example. Matters that are not mentioned as the fourth arrangement example can comply with the first to third arrangement examples. The fourth arrangement example may be implemented in combination with at least one of the first to third arrangement examples. In the fourth arrangement example, the imaging system can include the plurality of illumination sources 1a, 1b, . . . configured to irradiate the inspection object M using the cabin aisle 115 as a common-use portion with the terahertz wave TW, and the plurality of cameras 2a, 2b, . . . configured to capture the inspection object M irradiated with the terahertz wave. In the first seat row S1, the illumination sources 1a . . . that are some of the plurality of illumination sources 1a, 1b, . . . and the cameras 2a . . . that are some of the plurality of cameras 2a, 2b, . . . can alternately be arranged. In the second seat row S2, the illumination sources 1b . . . that are some of the plurality of illumination sources 1a, 1b, . . . and the cameras 2b . . . that are some of the plurality of cameras 2a, 2b, . . . can alternately be arranged. This arrangement is advantageous to alternately capture the left and right sides of the inspection object M passing through the cabin aisle 115 and early detect that the inspection object M holds a dangerous item.

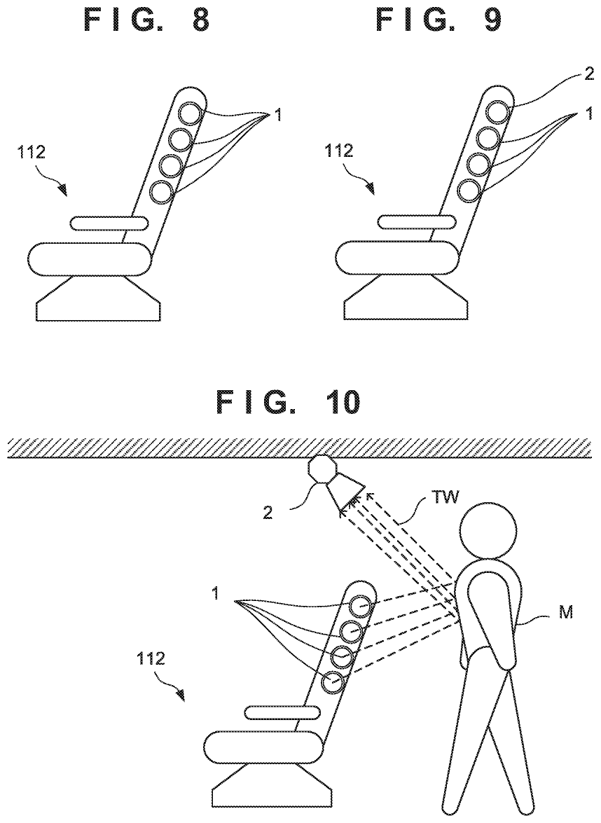

FIG. 8 schematically shows the coach 100 of the fifth arrangement example. Matters that are not mentioned as the fifth arrangement example can comply with the first to fourth arrangement examples. The fifth arrangement example may be implemented in combination with at least one of the first to fourth arrangement examples. In the fifth arrangement example, the imaging system can include the plurality of illumination sources 1 configured to irradiate the inspection object using the cabin aisle as a common-use portion with the terahertz wave, and a plurality of cameras (not shown) configured to capture the inspection object irradiated with the terahertz wave. The plurality of illumination sources 1 can include at least two illumination sources 1 arranged on the backrest of the seat 112, as shown in FIG. 8. This arrangement is advantageous to irradiate the inspection object with the terahertz wave from various angles or positions.

FIG. 9 schematically shows the coach 100 of the sixth arrangement example. Matters that are not mentioned as the sixth arrangement example can comply with the first to fourth arrangement examples. The sixth arrangement example may be implemented in combination with at least one of the first to fourth arrangement examples. In the sixth arrangement example, the imaging system can include the plurality of illumination sources 1 configured to irradiate the inspection object using the cabin aisle with the terahertz wave, and a plurality of cameras 2 configured to capture the inspection object irradiated with the terahertz wave. The plurality of illumination sources 1 can include at least two illumination sources 1 arranged on the backrest of the seat 112, as shown in FIG. 9. This arrangement is advantageous to irradiate the inspection object with the terahertz wave from various angles or positions. The plurality of cameras 2 can include at least one camera 2 arranged on, for example, the backrest of the seat 112, as shown in FIG. 9.

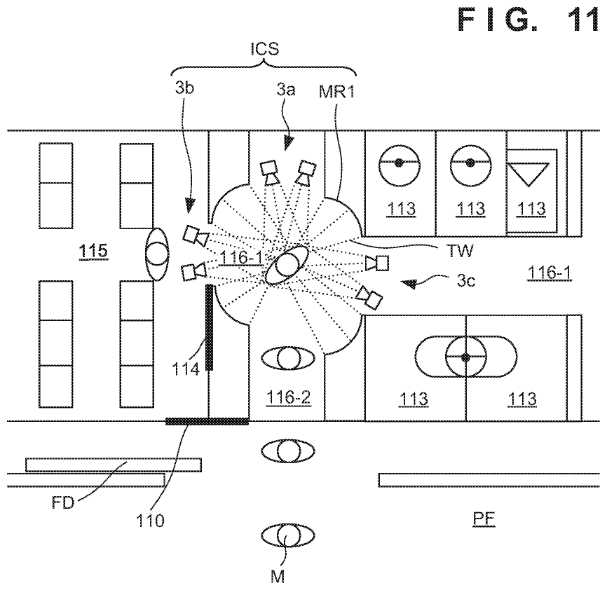

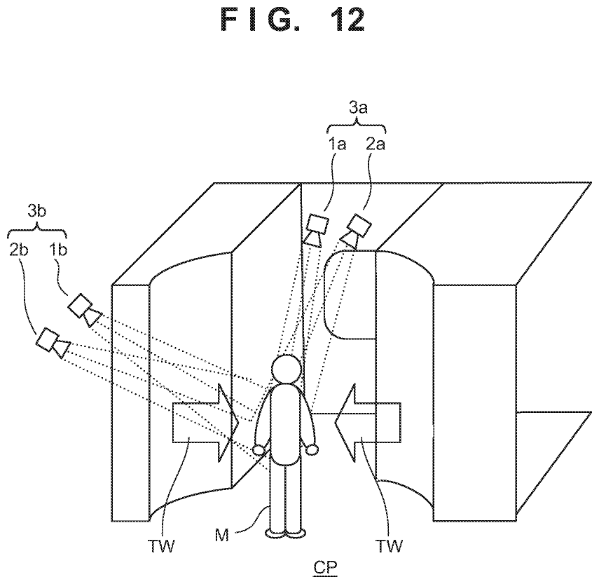

FIG. 10 schematically shows the coach 100 of the seventh arrangement example. Matters that are not mentioned as the seventh arrangement example can comply with the first to sixth arrangement examples. The seventh arrangement example may be implemented in combination with at least one of the first to sixth arrangement examples. In the seventh arrangement example, the imaging system can include the plurality of illumination sources 1 configured to irradiate the inspection object M using the cabin aisle with the terahertz wave TW, and the plurality of cameras 2 configured to capture the inspection object M irradiated with the terahertz wave TW. The plurality of illumination sources 1 can include at least one illumination source 1 arranged on, for example, the backrest of the seat 112. The plurality of cameras 2 can include at least one camera 2 arranged on the ceiling. The camera 2 arranged on the ceiling can visually be recognized from the inspection object M in FIG. 10, but may be embedded in the ceiling.

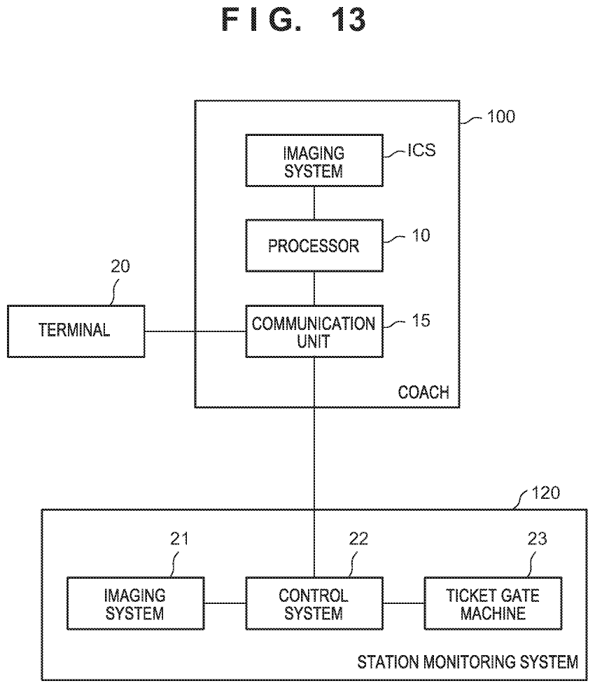

FIGS. 11 and 12 schematically show the coach 100 of the eighth arrangement example. Matters that are not mentioned as the eighth arrangement example can comply with the first to seventh arrangement examples. The eighth arrangement example may be implemented in combination with at least one of the first to seventh arrangement examples. In the eighth arrangement example, the imaging system ICS includes a reflecting surface MR1 configured to reflect the terahertz wave TW, and the reflecting surface MR1 can include a curved surface. The reflecting surface MR1 can be formed by, for example, a metal surface. A film of coating or the like or a poster made of paper or the like may be provided on the metal surface. Alternatively, for example, the reflecting surface MR1 may be formed by a surface of a member made of a resin or the like having a surface roughness equal to or less than the wavelength of an electromagnetic wave to irradiate, preferably 1/10 or less of the wavelength, and typically on an order of 10 to 100 micrometers. This arrangement makes it possible to reflect light scattered by the inspection object M or unirradiated light in the terahertz waves TW with which the plurality of illumination sources 1 irradiate the inspection object M by the reflecting surface MR1, irradiate the inspection object M again, and cause the light to enter the camera 2. Hence, this arrangement can improve the detection performance of the imaging system ICS.

FIG. 13 shows the arrangement of the coach 100 and the arrangement of a station monitoring system 120. Note that although an example in which the monitoring system is provided in the station will be described here, the application range of this technique is not limited to this example. For example, other examples of a place where a movable body departs/arrives are an airport and a port (ship). The coach 100 can include a processor 10 and a communication unit 15 in addition to the above-described imaging system ICS. The processor 10 performs processing of a signal output from the imaging system ICS. The processing can include deciding a risk concerning the inspection object M. The processing can include specifying the position of the inspection object M having a predetermined risk. Alternatively, the processing can include specifying the seat of the inspection object M having a predetermined risk. The processor 10 can be formed by, for example, a PLD (short for Programmable Logic Device) such as an FPGA (short for Field Programmable Gate Array), an ASIC (short for Application Specific Integrated Circuit), a general-purpose or dedicated computer in which a program is installed, or a combination of some or all of them.

The processor 10 can specify the seat of the inspection object M based on correspondence information that associates the feature information of the inspection object M with seat information assigned to a passenger having a feature corresponding to the feature information. The feature information can be information extracted by the processor 10 from an image captured by the imaging system ICS. The feature information may be, for example, a feature amount specified based on the shape, the size, and the like of a partial image extracted from an image captured by the imaging system ICS, may be information that specifies the type of a dangerous item, or may be information representing another feature. Alternatively, the feature information may be information representing the above-described risk. Extraction of the partial image from the image captured by the imaging system ICS can include, for example, extracting a portion having a brightness more than a predetermined brightness. AI (Artificial Intelligence) can be used to extract the feature information. More specifically, AI that has undergone deep learning is installed in the processor 10, and the feature information can be extracted by the AI. For example, information representing a risk in an image captured by the camera 2 appears in a different manner depending on the position and orientation of the camera 2. Hence, deep learning can be executed based on images captured by a plurality of cameras 2.

The processor 10 can transmit the result of the above-described processing to a terminal 20 set in advance via the communication unit 15. The terminal 20 can be carried by, for example, a conductor in the coach 100. The terminal 20 may include a terminal carried by a person other than the conductor in the coach 100, a terminal provided in a security office arranged in a station or the like, and a terminal provided in an administrative body such as a police station.

The station monitoring system 120 can include an imaging system 21, a control system 22, and a ticket gate machine 23. The imaging system 21 can include a camera configured to acquire an image formed by the terahertz wave TW. The imaging system 21 may include a camera configured to acquire an image formed by an electromagnetic wave (for example, visible light) of a wavelength other than the terahertz wave. The imaging system 21 can include a camera installed to capture the inspection object passing through at least the ticket gate machine 23 and configured to acquire an image formed by the terahertz wave TW. The ticket gate machine 23 can have not only a ticket gate function but also a function of reading seat information (information for specifying a reserved seat) of a ticket (including an electronic ticket held by a portable medium such as a portable terminal) held by the inspection object that undergoes ticket gating and notifying the control system 22 of the seat information.

The imaging system 21 can capture the inspection object passing through the ticket gate machine 23 using the terahertz wave TW and transmit the captured image to the control system. The control system 22 can decide the risk of the inspection object based on the image received from the imaging system 21. In addition, the control system 22 can extract the feature information of the inspection object from the image received from the imaging system 21. The feature information can be extracted by an extraction method that is the same as or similar to the extraction method of feature information by the above-described processor 10. The control system 22 can be formed by, for example, a general-purpose or dedicated computer in which a program is installed.

The control system 22 generates correspondence information that associates the feature information of the inspection object extracted from the image received from the imaging system 21 with the seat information read by the ticket gate machine 23. For example, the feature information can be information strongly suggesting holding of a firearm, and the seat information can be seat information read by the ticket gate machine 23 from a ticket held by the inspection object that holds the firearm. The correspondence information can be transmitted from the control system 22 to the coach 100. The feature information may include information that identifies the ID of the inspection object (that is, information that specifies an individual). If the imaging system 21 includes a visible light camera, the ID of the inspection object can be identified from the visible light image of the inspection object or from the visible light image by AI or the like. The visible light image of the inspection object having a predetermined risk can be transmitted to the coach 100 together with the above-described correspondence information and can further be transmitted to the terminal 20.

Hereinafter, a technique advantageous in improving crime prevention by a camera system installed in a facility will be described.

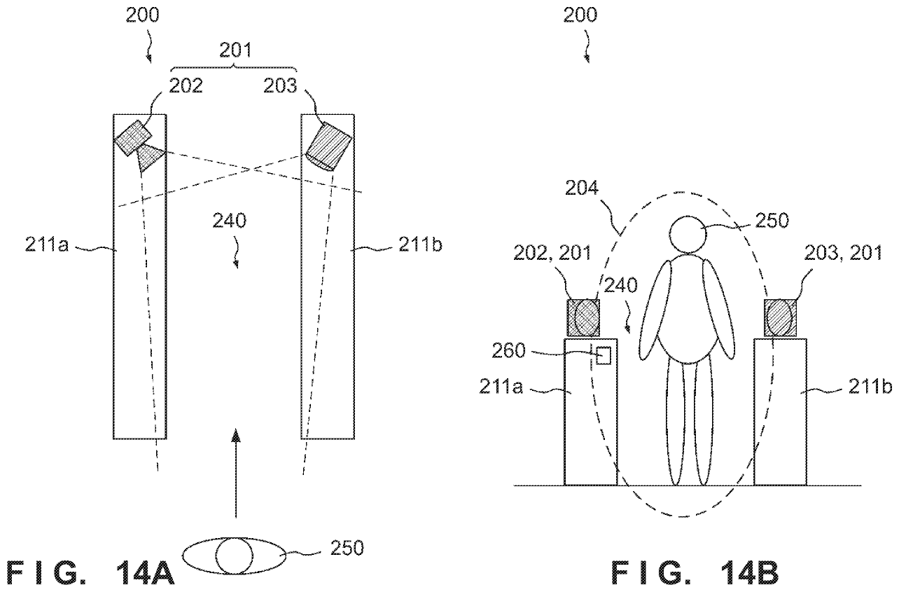

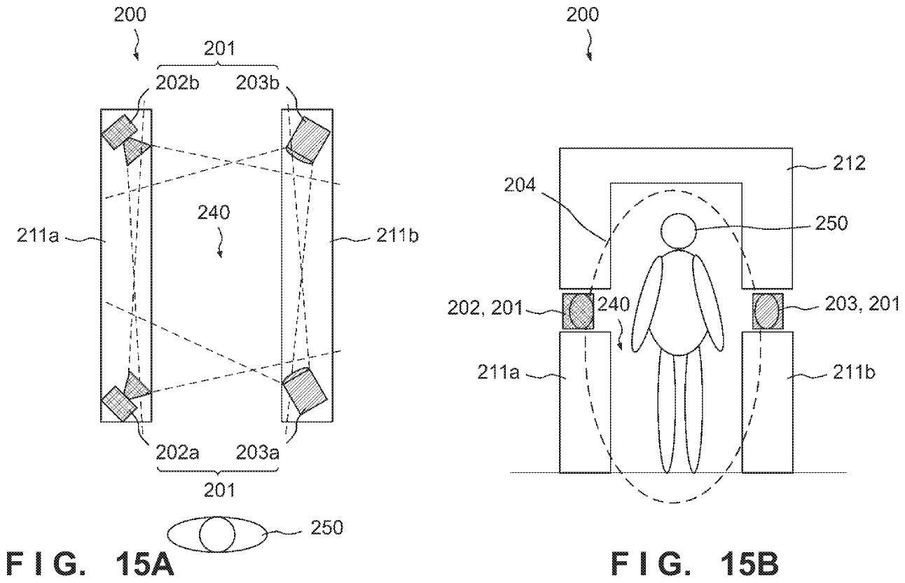

A camera system 200 according to some embodiments of the present invention will be described with reference to FIGS. 14A to 22. The camera system 200 according to this embodiment is installed in a facility. Examples of the facility are terminals such as a railroad station and an airport, a commercial facility, and an amusement facility. The camera system 200 according to this embodiment is installed in a structure of a railroad station or the like. Structures of a station include a station building in which a ticket gate, a ticket office, a waiting room, and the like are arranged, a platform at which a railroad coach arrives, a passage that connects the station building and the platform, and the like. Here, the passage can be not only a flat passage but also a place where passengers pass, such as a staircase, an escalator, or an elevator. In addition, a railroad coach is an example of a movable body. If the facility is an airport, the movable body is, for example, an airplane. The camera system 200 according to this embodiment can be a camera system arranged so as to form a part of the monitoring system of a station.

The camera system 200 includes an imaging system 201 configured to acquire an image formed by a terahertz wave reflected by an inspection object 250. The imaging system 201 can include at least one illumination unit 202 configured to irradiate a terahertz wave, and at least one camera 203 configured to acquire an image formed by the terahertz wave. The illumination unit 202 is also referred to as the irradiation unit. To discriminate a plurality of illumination units 202 and a plurality of cameras 203 in the following explanation, a suffix is added to each reference numeral, like an illumination unit 202“a” and a camera 203“a”. If the illumination units and the cameras need not be discriminated, they are expressed simply as “illumination unit 202” and “camera 203”. This also applies to other constituent elements.

In this embodiment, the camera 203 that detects a terahertz wave is of a type called active camera, and can be used in combination with the illumination unit 202. However, the camera is not limited to this, and may be a camera of a passive type. In this case, without illuminating the inspection object 250 with a terahertz wave irradiated from the illumination unit 202, and an image can be acquired by a terahertz wave radiated from the inspection object 250.

The imaging system 201 can be arranged to capture the inspection object 250 that uses the station. The inspection object 250 is normally a person but may be an animal other than a person or a robot. A terahertz wave passes through a fabric, a leather, and the like. For this reason, a processor (for example, a control system 22) (not shown) connected to the camera system 200 can detect a dangerous item such as a firearm, a cutting tool, or an explosive based on an image provided from the imaging system 201 of the camera system 200.

FIGS. 14A and 14B are a plan view and a front view, respectively, showing an arrangement example of a ticket gate machine 211 in which the imaging system 201 included in the camera system 200 according to the present invention is arranged. The ticket gate machine 211 is installed in a ticket gate of a station, and separates the inside of the ticket gate and the outside of the ticket gate. Here, the inside of the ticket gate can be an area that needs a ticket such as a platform ticket or a boarding ticket to enter. The ticket gate machine 211 may be an automatic ticket gate machine. The imaging system 201 is arranged to acquire an image of the inspection object 250 that passes through a passage 240 of the ticket gate machine 211. For example, the imaging system 201 may acquire the image of the inspection object 250 entering from the outside of the ticket gate to the inside of the ticket gate. A description will be made below assuming that the inspection object 250 passes from the outside of the ticket gate to the inside of the ticket gate in the direction of an arrow shown in FIG. 14A.

In the arrangement shown in FIGS. 14A and 14B, the ticket gate machine 211 includes a ticket gate machine 211a and a ticket gate machine 211b, which are arranged to face each other across the passage. That is, the width and length of the passage 240 of the ticket gate machine 211 can be decided by the ticket gate machine 211a and the ticket gate machine 211b. The imaging system 201 includes the illumination unit 202 arranged on the ticket gate machine 211a, and the camera 203 arranged on the ticket gate machine 211b. A terahertz wave irradiated from the illumination unit 202 can be specularly reflected by the inspection object 250 such as a person. For this reason, when the illumination unit 202 and the camera 203 are arranged on the ticket gate machine 211a and the ticket gate machine 211b, which face each other across the passage 240, respectively, the terahertz wave irradiated from the illumination unit 202 is readily reflected by the inspection object 250 and detected by the camera 203.

As shown in FIG. 14B, the illumination unit 202 can use a range 204 of almost the whole passage 240 as an irradiation range. The spread of the terahertz wave irradiated from the illumination unit 202 can be adjusted by using a lens or the like. In addition, the terahertz wave is reflected by a metal or the like. Hence, the inspection object 250 is illuminated even near the lower portion of the ticket gate machine 211a because the terahertz wave is reflected by the side surface of the ticket gate machine 211b. Furthermore, to effectively use the reflection of the terahertz wave by each side surface of the ticket gate machine 211 on the side of the passage 240, the illumination unit 202 and the camera 203 may be arranged near the end portion of the ticket gate machine 211 on the opposite side of the directions of the optical axes of the illumination unit 202 and the camera 203, as shown in FIG. 14A. That is, the illumination unit 202 and the camera 203 configured to capture the outer side of the ticket gate from the ticket gate machine 211 may be arranged near the end portion of the ticket gate machine 211 on the inner side of the ticket gate.

The arrangement of the illumination unit 202 and the camera 203 is not limited to the above-described arrangement. For example, the illumination unit 202 and the camera 203 may be arranged on the ticket gate machine 211a. Alternatively, for example, the illumination unit 202 and the camera 203 may be arranged near the center of the ticket gate machine 211, or may be arranged near the end portion on the outer side of the ticket gate in FIG. 14A. For one camera 203, the illumination unit 202 may be formed by a plurality of illumination devices. For example, the illumination unit 202 may be formed by a plurality of illumination devices whose terahertz wave irradiation directions are different. In addition, the illumination unit 202 and the camera 203 may be fixed to the ticket gate machine 211 in an immovable state, or may be arranged, for example, rotatably in accordance with the movement of the inspection object 250.

If the imaging system 201 of the camera system 200 is used as a surveillance camera, in some cases, post-processing such as image processing by a processor (not shown) at the subsequent stage of the imaging system 201 of the camera system 200 is facilitated by capturing the person who is the inspection object 250 one by one. The ticket gate machine 211 passes the person who is the inspection object 250 one by one at a high possibility. Hence, when the imaging system 201 is arranged in the ticket gate machine 211, the load of post-processing such as image processing can be suppressed. That is, the imaging system 201 can be arranged in a place where the inspection object 250 lines up. In addition, the time needed for the person that is the inspection object 250 to pass through the ticket gate machine 211 is about 1 sec. However, the imaging system 201 can acquire an image formed by a terahertz wave at a frame rate of 50 fps or more. For this reason, it is possible to perform capture one inspection object 250 at plurality of times. In the plurality of times of image capturing, the inspection object 250 may be captured wholly or may be captured only partially.

The imaging system 201 of the camera system 200 may include a sensor 260 configured to detect that the inspection object 250 approaches. For example, the ticket gate machine 211 may be provided with the sensor 260, as shown in FIG. 14B. Alternatively, for example, the sensor 260 may be added to the illumination unit 202 or the camera 203. The illumination unit 202 is controlled based on the output of the sensor 260. For example, the illumination unit 202 may start irradiating the terahertz wave in accordance with detection of the inspection object 250 by the sensor 260. This can suppress the power consumed by the imaging system 201.

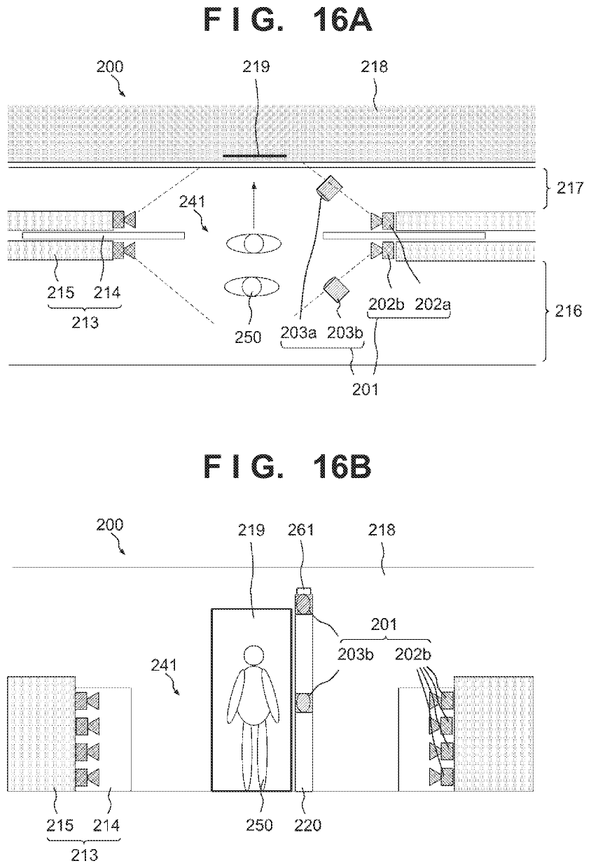

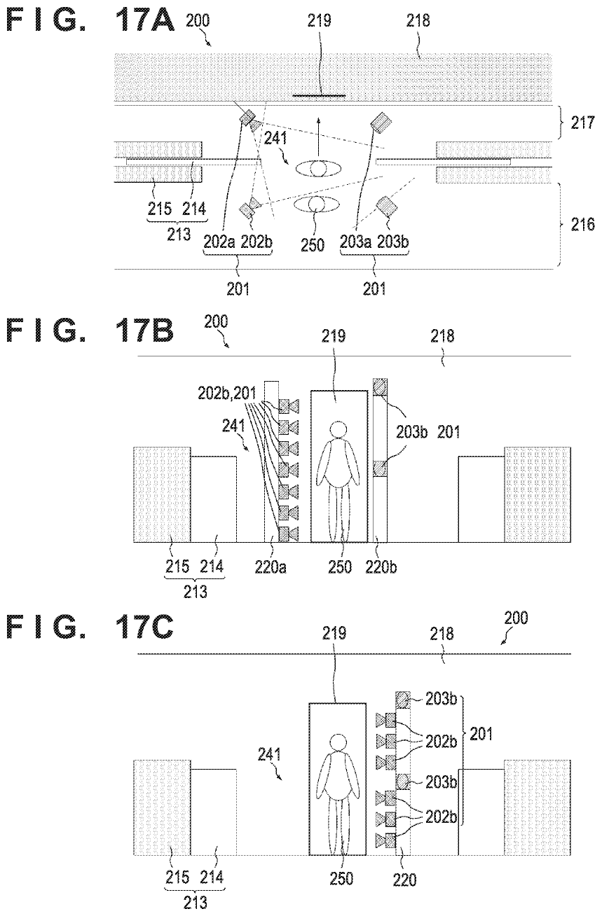

FIG. 15A shows an example in which as the imaging system 201, two sets of illumination units 202 and cameras 203 are arranged on the ticket gate machine 211. As shown in FIG. 15A, illumination units 202a and 202b are arranged on the ticket gate machine 211a, and cameras 203a and 203b are arranged on the ticket gate machine 211b. At this time, as shown in FIG. 15A, the illumination unit 202a and the camera 203a are arranged to illuminate and capture the inner side of the ticket gate from the ticket gate machine 211, and the illumination unit 202b and the camera 203b are arranged to illuminate and capture the outer side of the ticket gate from the ticket gate machine 211. With this arrangement, not only the front side but also the rear side of the inspection object 250 can be captured. At this time, as described above, to efficiently use terahertz waves irradiated from the illumination units 202a and 202b, the illumination unit 202a and the camera 203a may be arranged on the inner side of the ticket gate with respect to the illumination unit 202b and the camera 203b. However, the arrangement of the illumination units 202a and 202b and the cameras 203a and 203b is not limited to this, and they can freely be arranged, as described above. Additionally, as described above, each side surface of the ticket gate machine 211 on the side of the passage 240 may form a reflecting surface that reflects the terahertz wave. That is, each surface of the ticket gate machine 211 on the side of the passage 240 may be made of a metal, or may include a rough surface with an unevenness of about 1/10 of the wavelength of the terahertz wave. Additionally, for example, as shown in FIG. 15B, the ticket gate machine 211 may have a gate-shaped structure including an upper structure 212 for more reflection of the terahertz wave. At this time, each surface of the upper structure 212 on the side of the passage 240 may be made of a metal, or may include a rough surface with an unevenness of about 1/10 of the wavelength of the terahertz wave. When the terahertz wave is reflected or scattered by the surfaces of the ticket gate machine 211, the inspection object 250 is illuminated from various angles, and the quality of images obtained by the camera 203 can be improved.

Additionally, in FIGS. 14A to 15B, the illumination unit 202 and the camera 203 are illustrated large as separated bodies on the ticket gate machine 211 to simplify the description. However, the present invention is not limited to this. The terahertz wave can pass through a material such as a resin. For this reason, a window made of a resin may be provided in a part of the ticket gate machine 211, and the illumination unit 202 or the camera 203 may be arranged in the ticket gate machine 211. As the resin, for example, an appropriate material such as high-density polyethylene or cyclic olefin copolymer can be used. In the following explanation as well, the illumination unit 202 and the camera 203 are illustrated large in the drawings.

An example in which the imaging system 201 is applied to a partition wall 213 on a platform 216 of a station will be described next with reference to FIGS. 16A and 16B. FIGS. 16A and 16B are a plan view and a front view, respectively, showing an arrangement example of the partition wall 213 in which the imaging system 201 included in the camera system 200 according to the present invention is arranged. The imaging system 201 is arranged to be adjacent to the partition wall 213 configured to partition a platform 216 and a track-side area 217 and including a door portion 214 capable of opening and closing. The partition wall 213 is a so-called platform screen door installed on the platform 216. In this embodiment, the imaging system 201 acquires an image of the inspection object 250 that passes through a passage 241 when the door portion 214 of the partition wall 213 opens.

The imaging system 201 includes the illumination unit 202a and the camera 203a, which are arranged in the track-side area 217. The illumination unit 202a and the camera 203a perform illumination and image capturing of the passage 241 from the track-side area 217 when the door portion 214 opens. In addition, the imaging system 201 includes the illumination unit 202b and the camera 203b, which are arranged in the platform 216. The illumination unit 202b and the camera 203b perform illumination and image capturing of the passage 241 from the platform 216 when the door portion 214 opens. When the illumination unit 202a and the camera 203a, and the illumination unit 202b and the camera 203b are arranged, it is possible to acquire the front- and rear-side images of both the inspection object 250 that gets in a railroad coach 218 via a door 219 and the inspection object 250 that gets off the railroad coach 218 via the door 219. However, the present invention is not limited to this, and only the illumination unit 202a and the camera 203a or only the illumination unit 202b and the camera 203b may be arranged.

Each of the illumination units 202a and 202b may include a plurality of illumination devices, as shown in FIGS. 16A and 16B. As shown in FIGS. 16A and 16B, the illumination units 202a and 202b may be arranged at an end portion, in the direction of opening and closing the door portion 214, of a door pocket portion 215 in the partition wall 213, which stores the door portion 214 when opening the door portion 214. Additionally, as shown in FIG. 16A, when the door portion 214 opens, a part of the door portion 214 is not stored in the door pocket portion 215 in some cases. In this case, the side surface of the part of the door portion 214, which is not stored, may form a reflecting surface that reflects the terahertz wave, like the side surface of the above-described ticket gate machine 211 on the side of the passage 240. This makes it possible to more efficiently use the terahertz waves irradiated from the illumination units 202a and 202b. In addition, the vehicle body of the railroad coach 218 may be used as a reflecting surface that reflects the terahertz wave. When the door portion 214 of the partition wall 213 is opened to form the passage 241, the railroad coach 218 may have arrived. The vehicle body of the railroad coach 218 can be made of a metal. For this reason, the vehicle body of the railroad coach 218 can be used as the reflecting surface that reflects the terahertz wave.

In addition, as shown in FIG. 16B, the cameras 203a and 203b may be attached to a structure such as a pole 220. As the camera 203a or 203b, a plurality of image capturing devices may be used, as shown in FIG. 16B. The cameras 203a and 203b may be arranged, for example, at the height of the waist of the inspection object 250 or at a position higher than the inspection object 250, as shown in FIG. 16B. When the cameras 203a and 203b are arranged at a high position, even if the interval of the inspection objects 250 in the front-and-rear direction is small, the possibility that the images can be acquired one by one becomes higher than in a case in which the cameras 203a and 203b are arranged at a low position. In addition, when the cameras 203a and 203b are arranged at an angle with respect to the passage 241, the possibility of acquiring the front and rear images of the inspection object 250 becomes high.

The arrangement of the illumination units 202a and 202b and the cameras 203a and 203b is not limited to the arrangement shown in FIGS. 16A and 16B. For example, as shown in FIGS. 17A to 17C, the illumination units 202a and 202b may be attached to a structure such as the pole 220. At this time, as shown in FIGS. 17A and 17B, the illumination unit 202 and the camera 203 may be attached to separate poles 220a and 220b. Additionally, for example, as shown in FIG. 17C, the illumination unit 202 and the camera 203 may be attached to the same pole 220.

As described above, if the imaging system 201 is used as a surveillance camera, the load of post-processing such as image processing can be reduced by capturing the person who is the inspection object 250 one by one. Hence, the imaging system 201 included in the camera system 200 may be applied to the partition wall 213 installed in a station where a bullet train or a limited express for which persons line up and get in one by one stops. In this case, the width of the door 219 of the railroad coach 218 used for the bullet train or limited express is about 700 mm to 1,000 mm. Hence, in the arrangement shown in FIG. 16A or 16A, the maximum distance between the illumination unit 202 and the camera 203 can be decreased to, for example, about 1,100 mm (inclusive) to 2,000 mm (inclusive). This makes it possible to efficiently use the terahertz wave irradiated from the illumination unit 202. The bullet train or limited express often has a fixed train formation. Hence, the size of the door portion 214 can be changed in accordance with the size of the door 219 of the railroad coach 218. Hence, for example, the distance between the illumination unit 202 and the camera 203 adjacent to the door portion 214 corresponding to the door 219 having a small width (for example, 700 mm), may be, for example, 700 mm (inclusive) to 1,000 mm (inclusive). In this case, the maximum distance between the illumination unit 202 and the camera 203 may be, for example, 850 mm or more.

For example, the imaging system 201 may be applied to, for example, the partition wall 213 in a railroad station of a commuter train or the like. In this case, it may be possible to acquire images of persons one by one except during rush hours. Even in a case in which a plurality of inspection objects 250 simultaneously get in or get off, the inspection objects 250 often line up in two or three lines and get in. Each inspection object 250 can be distinguished by image processing or the like using a processor included in the camera system 200. In a commuter train or the like, the width of a door is about 1,300 mm to 2,000 mm For this reason, in the arrangement shown in FIG. 16A or 17A, the maximum distance between the illumination unit 202 and the camera 203 may be, for example, 1,500 mm (inclusive) to 3,000 mm (inclusive). The output of the terahertz wave irradiated from the illumination unit 202 may be changed in accordance with the distance between the illumination unit 202 and the camera 203. In this case, the illumination unit 202 whose distance to the camera 203 is longer may irradiate the terahertz wave at an output higher than the illumination unit of a shorter distance.

In some cases, the platform 216 is arranged outdoors. Hence, the imaging system 201 arranged on the platform 216 or the track-side area 217 is readily affected by the external environment. A terahertz wave is readily absorbed by water, and it may be impossible to obtain images with sufficient image quality in a highly humid environment such as a rainfall. Hence, the imaging system 201 may include a sensor 261 configured to detect the external environment, as shown in FIG. 16B. The illumination unit 202 is controlled based on the output of the sensor 261. For example, if the sensor 261 detects the information of humidity, and the humidity is high, the output of the illumination unit 202 to irradiate the terahertz wave may be increased. This can improve the quality of the image acquired by the camera 203.

In addition, for example, the illumination unit 202 or the camera 203 may be attached to the vehicle body of the railroad coach 218. That is, the camera system 200 may include an illumination unit or a camera mounted on the railroad coach 218. In this case, the camera system 200 can include a communication unit between the imaging system 201 arranged in a station and the imaging system including the illumination unit or the camera included in the railroad coach 218.

In addition, for example, the illumination unit 202 and the camera 203 may start operations when the door portion 214 of the partition wall 213 opens. For example, the imaging system 201 may synchronize with the operation of the door portion 214, or may include a sensor configured to detect that the door portion 214 has opened. This can suppress power consumption of the imaging system 201.

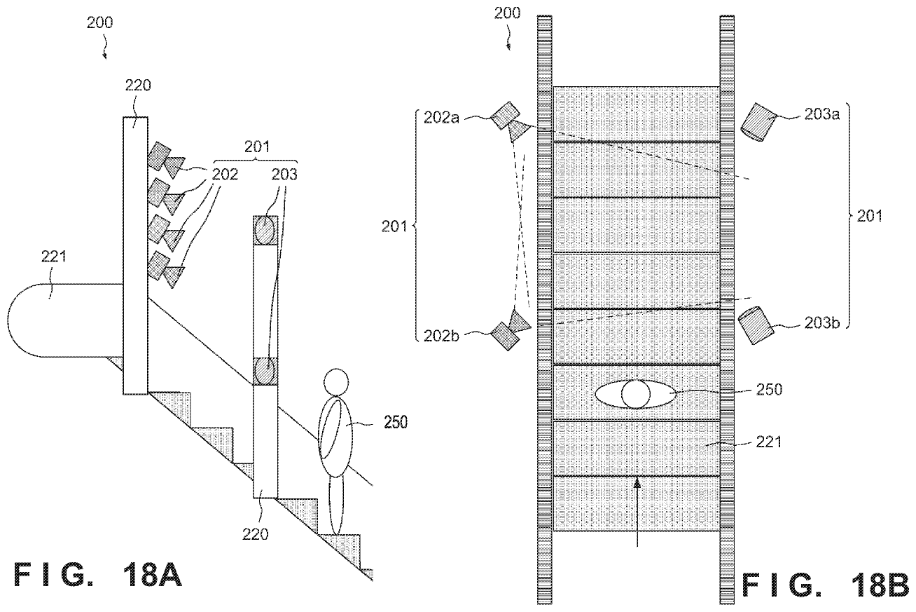

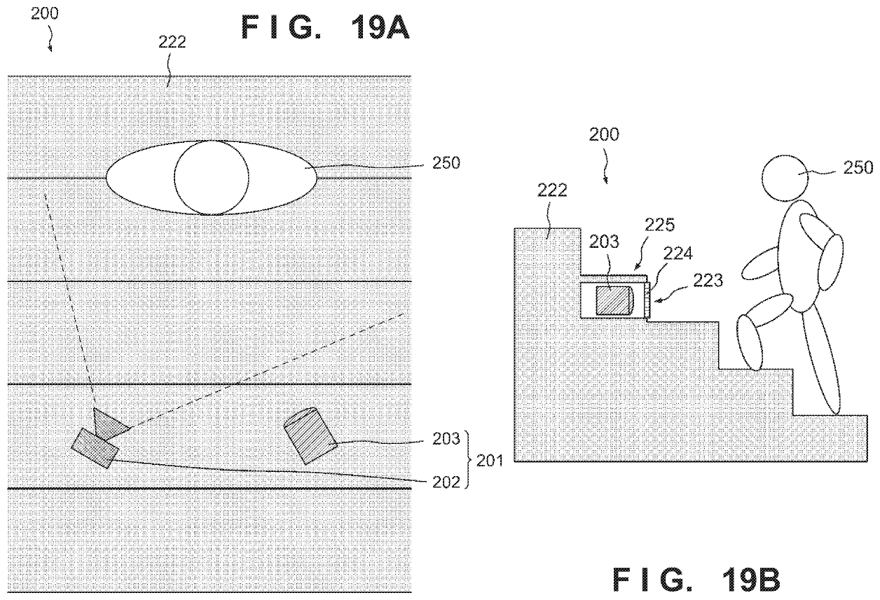

An example in which the imaging system 201 is applied to an escalator 221 will be described next with reference to FIGS. 18A and 18B. FIGS. 18A and 18B are a side view and a plan view, respectively, showing an arrangement example of the escalator 221 in which the imaging system 201 included in the camera system 200 according to the present invention is arranged.

The imaging system 201 is arranged to be adjacent to the escalator 221 to acquire the image of the inspection object 250 that passes through the escalator 221. In the arrangement shown in FIG. 18A, the imaging system 201 includes the illumination unit 202 and the camera 203. The illumination unit 202 may include a plurality of illumination devices, and the camera 203 may include a plurality of image capturing devices. In addition, the illumination unit 202 and the camera 203 may be arranged on separate structures such as the poles 220, as shown in FIG. 18A, or may be arranged on the same structure such as the pole 220. For example, as shown in FIG. 18A, the illumination unit 202 and the camera 203 may be arranged to face a direction opposite to the advancing direction of the escalator 221 and perform illumination and image capturing. This makes it possible to acquire an image of the inspection object 250 on the front side.

For example, as shown in FIG. 18B, the illumination unit 202 and the camera 203 may be arranged in a direction crossing the advancing direction of the escalator 221 while sandwiching the escalator 221. It is possible to obtain the same effects as the illumination unit 202 arranged on the ticket gate machine 211a and the camera 203 arranged on the ticket gate machine 211b described above. In addition, at this time, the illumination unit 202a and the camera 203a may be arranged to face the direction opposite to the advancing direction of the escalator 221 and perform illumination and image capturing, and the illumination unit 202b and the camera 203b may be arranged to face the advancing direction of the escalator 221 and perform illumination and image capturing. This makes it possible to capture not only the front side but also the rear side of the inspection object 250.

As described above, if the imaging system 201 is used as a surveillance camera, it may be advantageous that the person who is the inspection object 250 can be captured one by one. Since the escalator 221 operates at a predetermined speed, the possibility that the image of the inspection object 250 can be acquired one by one is high. Additionally, as shown in FIG. 18A, the escalator 221 includes steps. When the camera 203 is arranged at a high position, the possibility that the image can be acquired one by one becomes higher. On the escalator 221, the inspection objects 250 normally line up in one or two lines. For example, in the escalator 221 on which the inspection objects line up in two lines, the images of the inspection objects 250 may be acquired using two cameras 203. This raises the possibility that the images can be acquired one by one. As a result, the load of image processing at the subsequent stage of the imaging system 201 of the camera system 200 can be reduced.

In addition, as described above, a terahertz wave can pass through a resin or the like. For this reason, the illumination unit 202 or the camera 203 may be embedded in the floor, wall, or ceiling of the portion where the escalator 221 is arranged. For example, the illumination unit 202 may be installed on the deck board of the escalator 221 together with a normal illumination.

An example in which the imaging system 201 is applied to a staircase 222 will be described next with reference to FIGS. 19A and 19B. FIGS. 19A and 19B are a plan view and a sectional view, respectively, showing an arrangement example of the staircase 222 in which the imaging system 201 included in the camera system 200 according to the present invention is arranged.

The imaging system 201 is arranged in the staircase 222 to acquire the image of the inspection object 250 that passes through the staircase 222. In the arrangement shown in FIGS. 19A and 19B, the imaging system 201 includes the illumination unit 202 and the camera 203. The illumination unit 202 and the camera 203 are embedded in the staircase 222 and arranged to illuminate and capture the inspection object 250 from a window 224 of a riser portion 223 of the staircase 222. As shown in FIGS. 19A and 19B, the illumination unit 202 and the camera 203 can be arranged in the same riser portion 223 of the staircase 222.

Since the person who is the inspection object 250 goes up or down the staircase 222 one by one (or by about two steps), the image of the inspection object 250 can sequentially be acquired from the head (or foot) of the inspection object 250 to the foot (or head).

For the window 224 provided in the riser portion 223 of the staircase 222, various kinds of resins that pass a terahertz wave can be used, as described above. When an appropriate resin material is selected in accordance with the material used for the riser portion 223 or a tread portion 225 of the staircase 222, where the imaging system 201 is not arranged, the imaging system 201 can be made unnoticeable (its existence can be hidden).

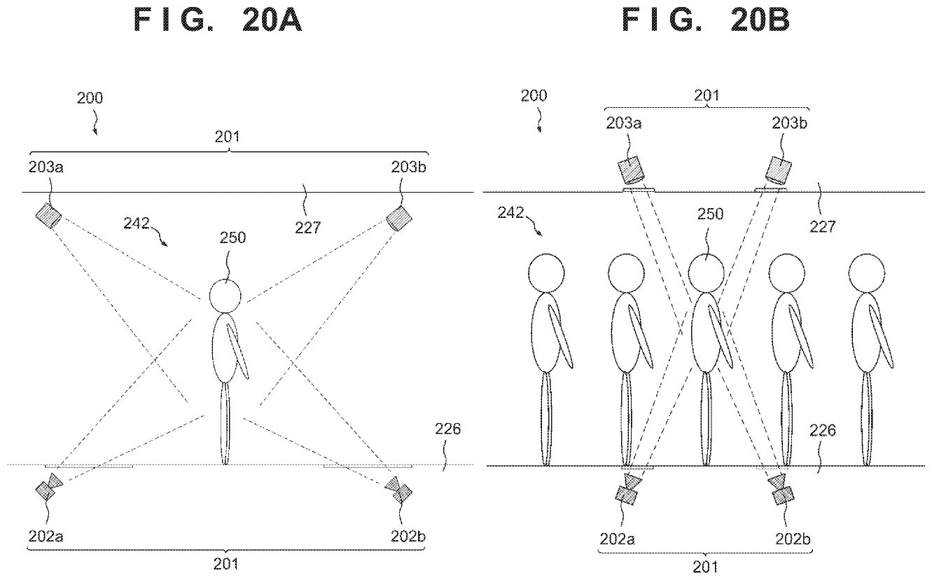

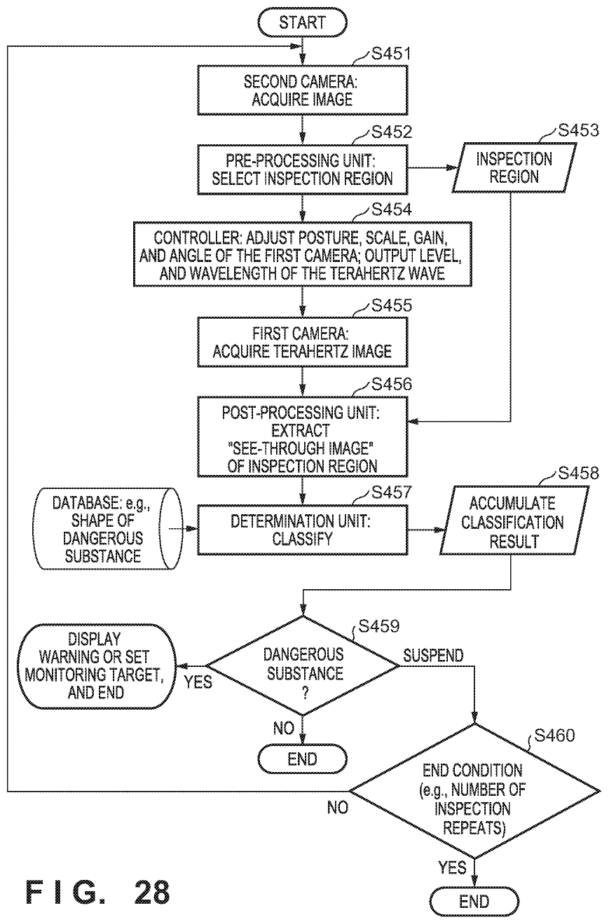

An example in which the imaging system 201 is applied to a passage 242 will be described next with reference to FIGS. 20A and 20B. FIGS. 20A and 28B are side views showing an arrangement example of the passage 242 in which the imaging system 201 included in the camera system 200 according to the present invention is arranged.

The imaging system 201 is arranged in the passage 242 to acquire the image of the inspection object 250 that passes through the passage 242. The imaging system 201 includes the illumination unit 202 and the camera 203. At this time, one of the illumination unit 202 and the camera 203 is arranged on a ceiling 227 of the passage 242, and the other of the illumination unit 202 and the camera 203 is embedded in a floor 226 of the passage 242. In the arrangement shown in FIGS. 20A and 20B, the camera 203 is arranged on the ceiling 227 of the passage 242, and the illumination unit 202 is embedded in the floor 226 of the passage 242. However, the present invention is not limited to this. The illumination unit 202 may be arranged on the ceiling 227 of the passage 242, and the camera 203 may be embedded in the floor 226 of the passage 242.

In the arrangement shown in FIGS. 20A and 20B, the illumination unit 202a and the camera 203a are arranged to perform illumination and image capturing from one side of the passage 242 in the passing direction to the other side. In addition, the illumination unit 202b and the camera 203b are arranged to perform illumination and image capturing from the other side of the passage 242 in the passing direction to the one side. This makes it possible to acquire the front- and rear-side images of the inspection object 250 that advances in both the two passing directions of the passage 242. However, the present invention is not limited to this, and only the illumination unit 202a and the camera 203a may be arranged on the passage 242.

FIG. 20B shows an example in which the cameras 203a and 203b are embedded in the ceiling 227 of the passage 242. Accordingly, the cameras 203a and 203b can be made unnoticeable (their existence can be hidden) as compared to a case in which the cameras 203a and 203b are suspended from the ceiling 227, as shown in FIG. 20A. In addition, the optical axis of the illumination unit 202 or the camera 203 is set at a larger angle with respect to the advancing direction of the inspection object 250 in the arrangement shown in FIG. 20B than in the arrangement shown in FIG. 20A. When the angles of the optical axes are set large, as indicated by dotted lines shown in FIGS. 20A and 20B, the possibility that the images of the inspection object 250 can be acquired one by one can become high.

Additionally, in the arrangement shown in FIGS. 20A and 20B, one of the illumination unit 202 and the camera 203 is arranged in the floor 226, and the other is arranged on the ceiling 227. As described above, a terahertz wave can be specularly reflected by the inspection object 250. Hence, when the illumination unit 202 and the camera 203 are arranged to face each other, the terahertz wave irradiated from the illumination unit 202 can readily be detected by the camera 203.

However, the arrangement of the illumination unit 202 and the camera 203 on the passage 242 is not limited to the arrangement shown in FIGS. 20A and 20B. For example, the illumination unit 202 and the camera 203 may be arranged on a side wall of the passage 242 or the like. Both the illumination unit 202 and the camera 203 may be arranged on the floor 226 or the ceiling 227. In this case, the floor 226 or the ceiling 227 on which the illumination unit 202 and the camera 203 are not arranged may function as a reflecting surface that reflects the terahertz wave. For example, the entire interior of the passage 242 except a portion of the illumination unit 202 or the camera 203, which functions as a window to pass the terahertz wave, may function as a reflecting surface that reflects the terahertz wave. Additionally, for example, the illumination unit 202 may include a plurality of illumination devices. In this case, the plurality of illumination devices included in the illumination unit 202 may be arranged in an appropriate number in an appropriate place such as the floor 226, the ceiling 227, or the side wall.

As described above, when the imaging system 201 is arranged in the staircase 222 or the passage 242, a plurality of cameras 203 may be arranged in the widthwise direction of the staircase 222 or the passage 242. Accordingly, the possibility that the image of the inspection object 250 can be captured one by one becomes high. In addition, the imaging system 201 may be arranged in a portion of the staircase 222 or the passage 242, where the width decreases. In the portion of the staircase 222 or the passage 242, where the width decreases, the inspection object 250 can easily line up.

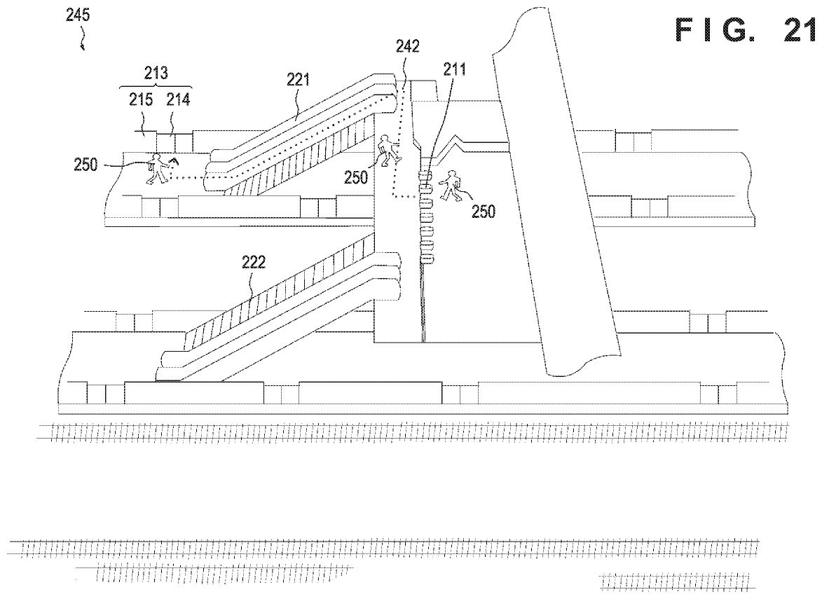

FIG. 21 is a view showing an arrangement example of a station 245 in which the imaging system 201 included in the camera system 200 is arranged. As described above, the imaging system 201 can be arranged on the ticket gate machine 211 at the ticket gate, the passage 242, the escalator 221, the staircase 222, the partition wall 213, or the like. The place to arrange the imaging system 201 including the illumination unit 202 and the camera 203 included in the camera system 200 according to this embodiment is not limited to the above-described places. For example, the imaging system 201 may be arranged in another place such as the entrance or hand wash basin of a restroom, where it is considered that the image of the inspection object 250 can be acquired one by one. The above-described imaging system 201 including the illumination unit 202 and the camera 203 and configured to acquire an image using the terahertz wave may be arranged in a place where a normal surveillance camera using visible light is installed.

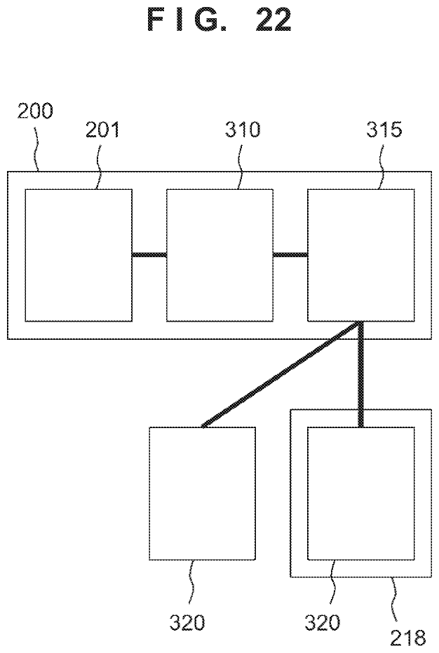

Additionally, the camera system 200 according to this embodiment can monitor the inspection object 250 shown in FIG. 21 in cooperation with the railroad coach 218. FIG. 22 shows an arrangement example of a monitoring system in which the camera system 200 monitors the inspection object 250 in cooperation with the railroad coach 218. The camera system 200 can include the control system 310 and a communication unit 315 in addition to the above-described imaging system 201 arranged in the station. The control system 310 processes a signal output from the imaging system 201. The processing can include deciding a risk concerning the inspection object 250. The processing can include specifying the position of the inspection object 250 having a predetermined risk. Alternatively, the processing can include specifying the seat of the inspection object 250 that has got in the railroad coach 218 based on, for example, a ticket that the inspection object 250 with the predetermined risk has put into the ticket gate machine 211 when passing through the ticket gate machine 211. The control system 310 can be formed by, for example, a PLD (short for Programmable Logic Device) such as an FPGA (short for Field Programmable Gate Array), a processor such as an ASIC (short for Application Specific Integrated Circuit), or a general-purpose or dedicated computer in which a program is installed, or a combination of some or all of them.

The control system 310 can specify the inspection object 250 based on the feature information of the inspection object 250 and correspondence information that associates the feature information with seat information assigned to a passenger having a feature corresponding to the feature information. The feature information can be information extracted by the control system 310 from an image obtained by the imaging system 201. The feature information may be, for example, a feature amount specified based on the shape, the size, and the like of a partial image extracted from an image obtained by the imaging system 201, may be information that specifies the type of a dangerous item, or may be information representing another feature. Alternatively, the feature information may be information representing the above-described risk. Extraction of the partial image from the image acquired by the imaging system 201 can include, for example, extracting a portion having a brightness more than a predetermined brightness. AI (Artificial Intelligence) can be used to extract the feature information. More specifically, AI that has undergone deep learning is installed in the control system 310, and the feature information can be extracted by the AI. For example, information representing a risk in an image captured by the camera 203 appears in a different manner depending on the position and orientation of the camera 203. Hence, deep learning can be executed based on images captured by a plurality of cameras 203.

The control system 310 can transmit the result of the above-described processing to a terminal 320 set in advance via the communication unit 315. The terminal 320 can be carried by, for example, a conductor in the railroad coach 218. The terminal 320 may include a terminal carried by a person other than the conductor in the railroad coach 218, a terminal provided in a security office arranged in a station or the like, and a terminal provided in an administrative body such as a police station.

The imaging system 201 can acquire the image of the inspection object 250 that passes through the ticket gate machine 211 and transmit the obtained image to the control system 310. The control system 310 can decide the risk of the inspection object based on the image received from the imaging system 201. In addition, the control system 310 can extract the feature information of the inspection object from the image received from the imaging system 201.

The control system 310 generates correspondence information that associates the feature information of the inspection object 250 extracted from the image received from the imaging system 201 with seat information read by the ticket gate machine 211. For example, the feature information can be information strongly suggesting holding of a gun, and the seat information can be seat information read by the ticket gate machine 211 from a ticket held by the inspection object 250 that holds the gun. The correspondence information can be transmitted from the control system 310 to the terminal 320 in the railroad coach 218. The feature information may include information that identifies the ID of the inspection object 250 (that is, information that specifies an individual). The imaging system 201 may include a visible light camera, and the ID of the inspection object 250 can be identified from the visible light image of the inspection object 250 or from the visible light image by AI or the like. The visible light image of the inspection object having a predetermined risk can be transmitted to the railroad coach 218 together with the above-described correspondence information and can further be transmitted to the terminal 320. A case in which the image of the inspection object 250 is acquired by the imaging system 201 arranged on the ticket gate machine 211 has been described here. However, tracking of the inspection object 250 may be started or continued based on an image obtained from the imaging system 201 arranged on the partition wall 213, the escalator 221, the staircase 222, or the passage 242. In addition, tracking of the inspection object 250 may be started based on an image obtained by the imaging system 201 arranged on the ticket gate machine 211, and after that, tracking of the inspection object 250 may be continued using a surveillance camera using visible light.

Hereinafter, a processing system capable of more advantageously executing an inspection using a terahertz wave will be described. In the following descriptions, terahertz waves include electromagnetic waves within the frequency range of 30 GHz to 30 THz. The concept of electromagnetic waves can include visible light, infrared light, and a radio wave such as a millimeter wave.

### First Embodiment

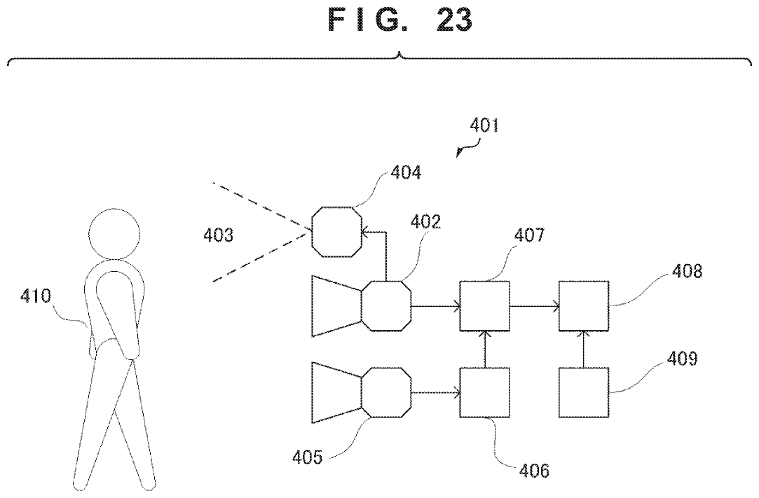

The outline of a processing system 401 according to the first embodiment will be described with reference to FIG. 23. The processing system 401 includes a first imaging system including a first illumination source 404 and a first camera 402, a second imaging system including a second camera 405, and a processor including a pre-processing unit 406 and a post-processing unit 407.

The first camera 402 of the first imaging system acquires a first image based on a terahertz wave 403 of a first wavelength radiated from the first illumination source 404. An inspection object 410 is irradiated with the terahertz wave 403 radiated from the first illumination source 404. If the inspection object 410 is a dressed person, the terahertz wave 403 passes through the fibers of clothes and is reflected by a metal or ceramic held by the inspection object 410. A specific substance, for example, RDX (trimethylenetrinitroamine) that is an explosive is known to absorb a terahertz wave near 0.8 THz, and therefore, the reflected wave decreases. The first camera 402 acquires the first image based on the reflected wave.

The second camera 405 of the second imaging system acquires a second image from an electromagnetic wave of a wavelength different from that of the terahertz wave irradiated from the first illumination source 404. As the electromagnetic wave of a different wavelength, visible light, infrared light, or a millimeter wave can be used. When using infrared light, an illumination source (not shown) different from the first illumination source 404 may be prepared. The second image acquired by the second camera 405 is processed by the pre-processing unit 406. The pre-processing unit 406 performs processing of detecting an inspection region from the second image.

If the second image is acquired by visible light, and the inspection object 410 is a person, detection of the inspection region may be performed by detecting a specific part of clothes as the inspection region. The inspection region may be specified by creating a model by machine learning and classifying a region of the captured second image by the model. Alternatively, the region may be specified based on the information of the shape of an object stored in a database 409. If the second image is acquired by a millimeter wave, a portion where the intensity distribution in the image is higher than a threshold or a portion where the intensity difference is large may be detected as the inspection region. If infrared light is used to acquire the second image, a portion with little radiation of infrared light caused by water or a specific portion of clothes in an image detected by night vision may be detected as the inspection region. Even in a dark place or a place with a poor view due to the weather, the inspection region can be detected using the infrared light or a millimeter wave. When detecting the inspection region from an image of a dressed person, an unnaturally swelling portion of clothes, the chest portion of the person, or a pocket portion of clothes may be detected as the inspection region.

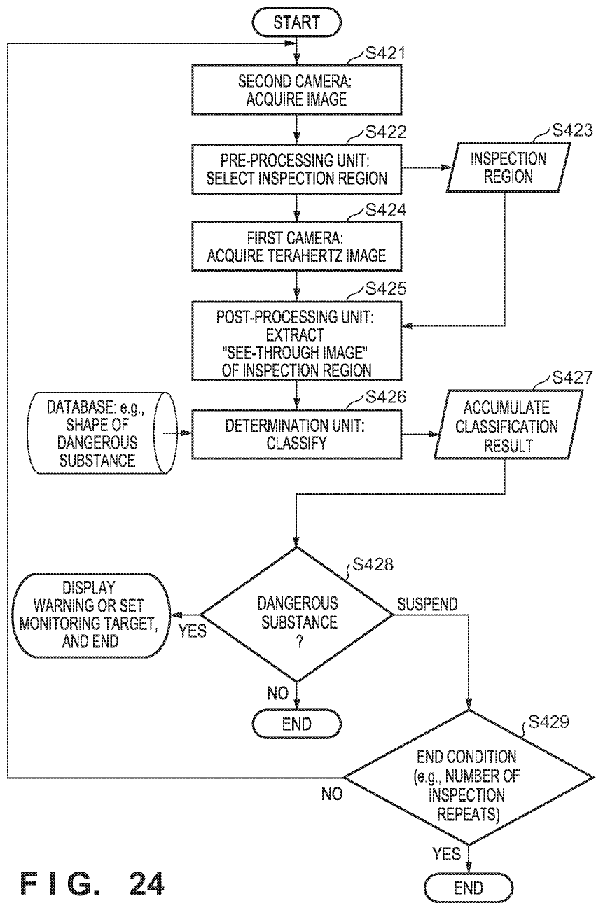

The inspection of the inspection object 410 by the processor will be described based on FIG. 24. The pre-processing unit 406 detects the inspection region from the second image acquired by the second camera 405 (step S421) by the above-described method (steps S422 and S423). The post-processing unit 407 performs processing of image data for the information of the region of the first image corresponding to the inspection region detected from the second image (step S425). The first image is an image acquired by the first camera 402 using a terahertz wave (step S424), and is an image obtained by seeing through clothes or the like. If a metal or ceramic object exists under the clothes, an image can be obtained from the reflected wave. Hence, the shape of the object can be detected by processing the first image. After the inspection region is detected from the second image, the region in the first image corresponding to the inspection region is selected by comparing the first image and the second image. Subsequent image processing for the first image is performed for the region corresponding to the inspection region detected from the second image.

When the region corresponding to the inspection region is selected from the first image, and image processing is performed, the processing can be performed while reducing unnecessary information. For this reason, the processing load can be reduced as compared to processing of the entire image data, and the speed can be increased. Hence, even if the inspection object 410 is moving, features can be detected from the first image a plurality of times in a short moving distance during a short time. A determination unit 408 estimates the object under the clothes based on the plurality of detected features (step S426). The plurality of features may be features of a part of the object. The determination unit 408 may classify the shape of the object detected from the first image based on the data in the database 409. The classification may be done using a model created by machine learning. It is considered that the information of the shape obtained from the image may be the information of a part of the object because of the movement of the inspection object 410 or the positional relationship between the inspection object and the camera. Even in this case, the estimation accuracy can be improved by classifying the features based on the information of the plurality of features, accumulating a plurality of results, and performing determination based on the accumulated classification results (step S427).

When the processing system is used in a security monitoring system, the risk of the object detected from the inspection region is determined based on the accumulation of the classification results for the inspection object 410 (step S428). As for the determination, determination based on the accumulation result of classifications may be performed based on a model by machine learning. If it is determined that the inspection object 410 holds a dangerous substance, it is possible to notify the outside that the inspection object 410 holds a dangerous substance. When the inspection object 410 passes through a gate in which the processing system is arranged, the processing system may notify the outside of a warning. When the inspection object 410 puts in a ticket and passes through a ticket gate, the processing system may link the ticket with the inspection object 410 and notify that the inspection object 410 is a monitoring target. If the second image is obtained using visible light, the inspection object 410 can be displayed such that it can easily be seen by displaying the second image and the first image on a monitor in a superimposed manner. When the determination is suspended, the inspection is repeated until the end condition is satisfied. The end condition may be the number of repetitions of the inspection (S429).

### Second Embodiment

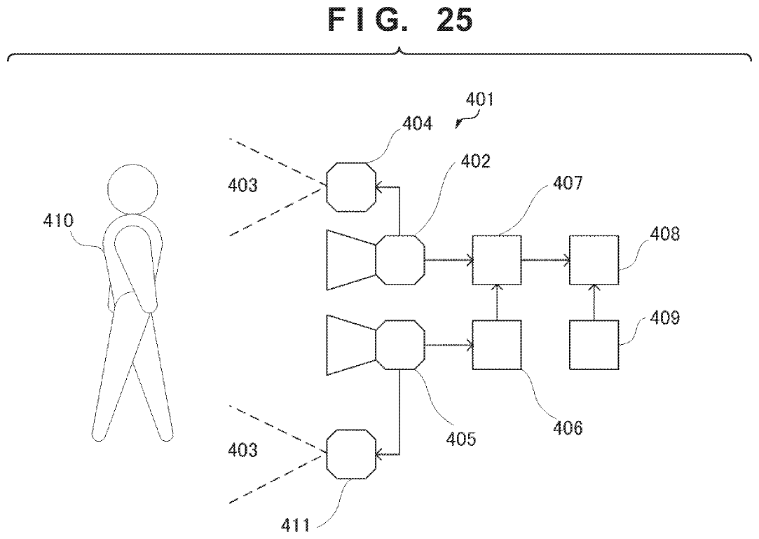

In this embodiment, a second imaging system is provided with a second illumination source 411 that radiates a terahertz wave. This embodiment will be described with reference to FIG. 25. The second illumination source 411 is an illumination source that generates a terahertz wave of a second wavelength different from a first illumination source 404. As described in the first embodiment, there is known a specific substance that absorbs a terahertz wave of a specific wavelength. Hence, a terahertz wave of a first wavelength (about 0.8 THz for RDX that is an explosive) that is a wavelength the specific substance readily absorbs is radiated from the first illumination source 404 to an inspection object 410. If the inspection object 410 holds a substance with a characteristic to easily absorb the terahertz wave of the first wavelength, reflection in the portion where the substance is held become small. On the other hand, when a wavelength (about 0.5 THz when the first wavelength is 0.8 THz) that is little absorbed by the specific substance is selected as the terahertz wave of the second wavelength generated by the second illumination source 411, the specific substance reflects the terahertz wave of the second wavelength. The substance can be specified using the difference between reflected waves from the specific substance for the same inspection region.

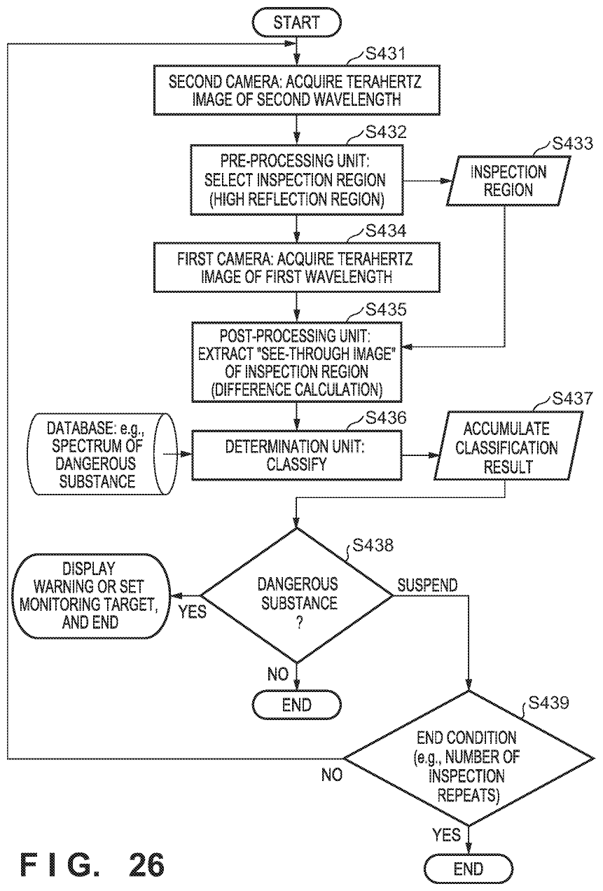

Processing according to this embodiment will be described based on FIG. 26. A pre-processing unit 406 detects, as the inspection region, a high reflection region in the second image acquired by the terahertz wave of the second wavelength (steps S431 and S432). A post-processing unit 407 acquires a first image (step S434) captured by a first camera 402 based on a terahertz wave of a first wavelength, and starts processing image data for a region of the first image corresponding to the inspection region detected from the second image. The post-processing unit 407 can calculate the difference between the information of the inspection region in the second image and the information of the region of the first image corresponding to the inspection region (step S435).

Data of a portion where reflection and absorption in the second image are almost equal to those in the first image is almost canceled by calculating the difference between the two pieces of information. However, data of a portion where reflection and absorption are different between the first wavelength and the second wavelength is not canceled even by calculating the difference between the two images. In this way, the spectrum analysis of the substance in the inspection region can be performed using the difference in the rate of terahertz wave absorption by the substance. The type of the substance can be estimated using the spectrum analysis. In addition, since scattering or reflection by clothes is canceled, an unnecessary signal from the clothes can be reduced from the obtained image information, and the signal-to-noise ratio of the image can be improved.

If person as the inspection object holds a substance that readily absorbs the first wavelength, the substance detected in the inspection region can be classified based on the difference in the absorption rate between the first wavelength and the second wavelength (step S436). As for the classification, when the relationship between a specific substance and a wavelength is held in a database 409, a determination unit 408 can perform the classification based on the database 409. The determination unit 408 may perform the classification using a model created by machine learning. With the above-described method, it is possible to estimate that the inspection object 410 holds the substance that absorbs the specific wavelength. It is known that dangerous substances exist among the substances that absorb a terahertz wave of a specific wavelength. The existence of a dangerous substance can be estimated by spectrum analysis. The detection accuracy can be raised by accumulating a plurality of spectrum analysis results (step S437).

It is thus determined that the inspection object 410 may hold a dangerous substance (step S438). As for the determination, determination based on the accumulation result of classifications may be performed based on a model by machine learning. If it is determined that a dangerous substance is held, the processing system notifies the outside that the inspection object 410 holds a dangerous substance. When the inspection object 410 passes through a gate in which the processing system is arranged, the processing system may notify the outside of a warning. When the person of the inspection object 410 puts in a ticket and passes through a ticket gate, the processing system may link the ticket with the inspection object 410 and notify the outside of the person as a monitoring target. As for the wavelength of the terahertz wave irradiated from the second illumination source 411, a plurality of illumination sources capable of irradiating terahertz waves of a plurality of, that is, three or more wavelengths may be combined in accordance with the absorption spectrum of a substance to be detected. When the determination is suspended, the inspection is repeated until the end condition is satisfied. The end condition may be the number of repetitions of the inspection (S439).

### Third Embodiment

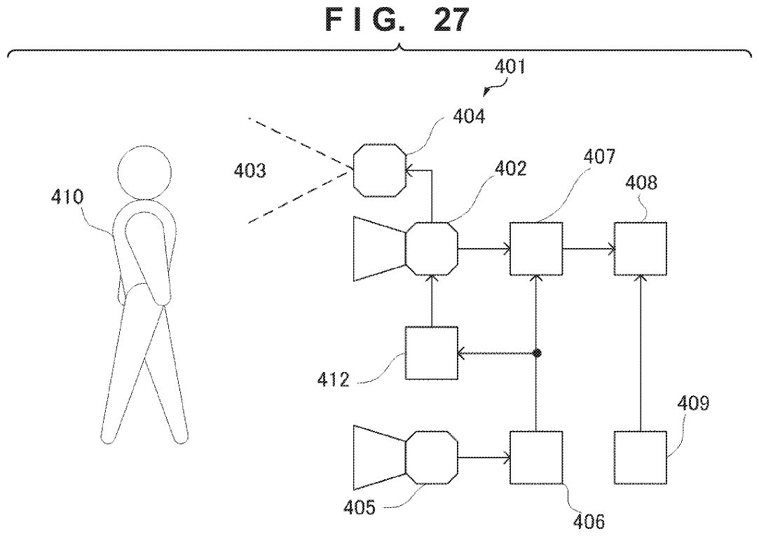

In this embodiment, based on detection of a specific region in a second image captured by a second imaging system a control unit 412 is controlled to control a first illumination source 404 and a first camera 402 in a first imaging system. This embodiment will be described with reference to FIGS. 27 and 28.

A second camera 405 of the second imaging system acquires a second image from an electromagnetic wave of a wavelength different from a terahertz wave radiated from the first illumination source 404. As the electromagnetic wave of a different wavelength, visible light, infrared light, or a millimeter wave can be used. The second image acquired by the second camera 405 is processed by a pre-processing unit 406. The pre-processing unit 406 detects an inspection region from the second image (steps S452 and S453). Detection of the inspection region is performed as described in the first embodiment.

Conditions at the time of capturing by the first camera are controlled in accordance with the position and range of the inspection region detected from the second image and the state of the inspection region. The conditions include control of the posture of the first camera, control of a gain for an acquired image, and control of a capturing range for zooming or trimming and an angle of view (step S454). The output level (output power) and the wavelength of the terahertz wave irradiated from the first illumination source 404 may be changed in accordance with the strength of a reflected signal from the inspection region or a target object in the inspection region. By this control, the inspection accuracy can be raised. The first imaging system controlled by the control unit 412 acquires a first image based on the terahertz wave of a first wavelength (step S455).

A post-processing unit 407 performs processing of the inspection region based on the acquired first image (step S456). After that, a determination unit 408 performs determination and classification of an object (steps S457, S458, and S459). When the processing system is a security monitoring system, a risk is determined based on the accumulation of classification results. If it is determined that an inspection object 410 holds a dangerous substance, the processing system notifies the outside that the inspection object 410 holds a dangerous substance. When the inspection object 410 passes through a gate in which the processing system is arranged, the processing system may notify the outside of a warning. When the inspection object 410 puts in a ticket and passes through a ticket gate, the processing system may link the ticket with the inspection object 410 and set the inspection object 410 to a monitoring target. When the determination is suspended, the inspection is repeated until the end condition is satisfied. The end condition may be the number of repetitions of the inspection (S460).

### Fourth Embodiment

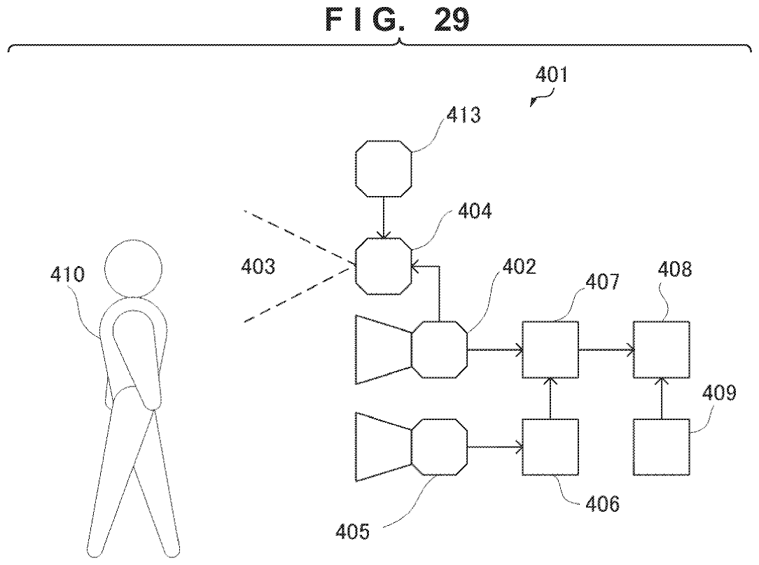

In this embodiment, an environment monitoring unit 413 configured to monitor a humidity around a processing unit is provided. This embodiment will be described with reference to FIG. 29. A terahertz wave is readily absorbed by water vapor. A terahertz wave of a longer wavelength is hardly affected by water vapor. Hence, the environment monitoring unit 413 is provided to measure the humidity, and the imaging system is controlled so as to be hardly affected by the peripheral environment.

More specifically, if the environment monitoring unit 413 detects that the humidity has become high, the wavelength of a terahertz wave 403 radiated from a first illumination source 404 is switched to a wavelength longer than the wavelength currently under use. In accordance with the humidity, the wavelength may be switched to a wavelength (a region that exists near a wavelength of 1.2 mm or 0.75 mm, where attenuation of atmosphere is specifically small) hardly affected by water vapor. When the wavelength of the terahertz wave becomes long, the resolution of an image captured by the camera lowers. However, it is possible to reduce the influence of water vapor and continue inspection.

### Fifth Embodiment

In this embodiment, capturing is performed using terahertz waves of different wavelengths. A second image is acquired using a terahertz wave of a second wavelength longer than the wavelength in capturing a first image, and an inspection region is detected from the second image. The inspection region may be detected as a region including an object of a predetermined shape using a model created by machine learning, or a region where the spectrum of a reflected wave of a predetermined wavelength changes may be detected as the inspection region.

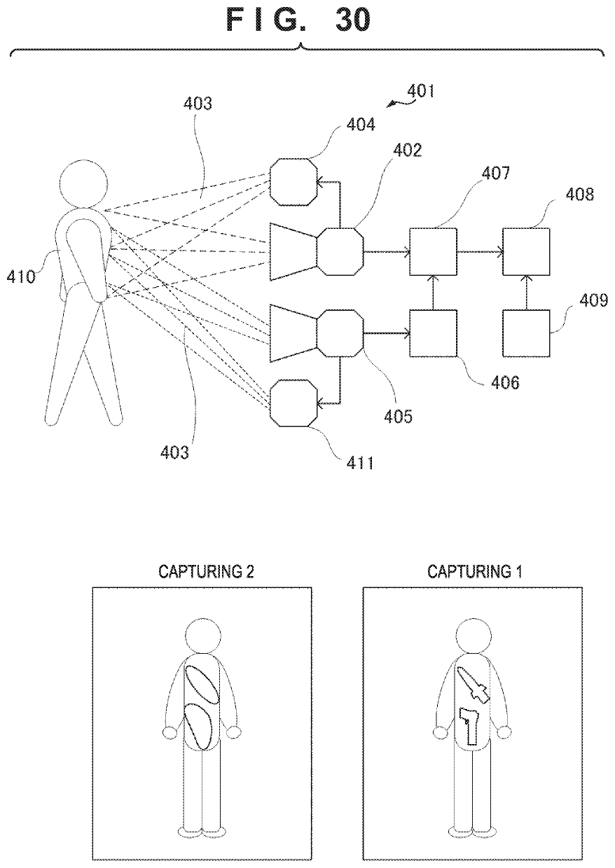

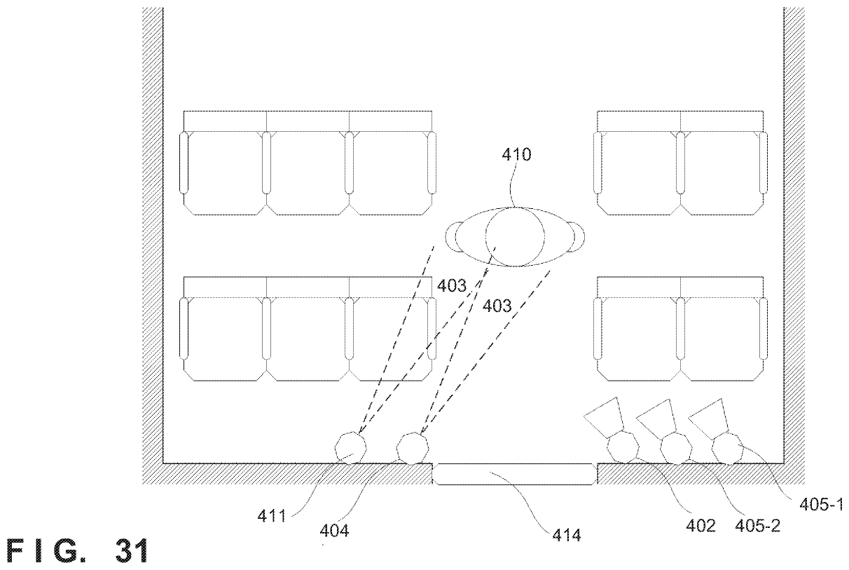

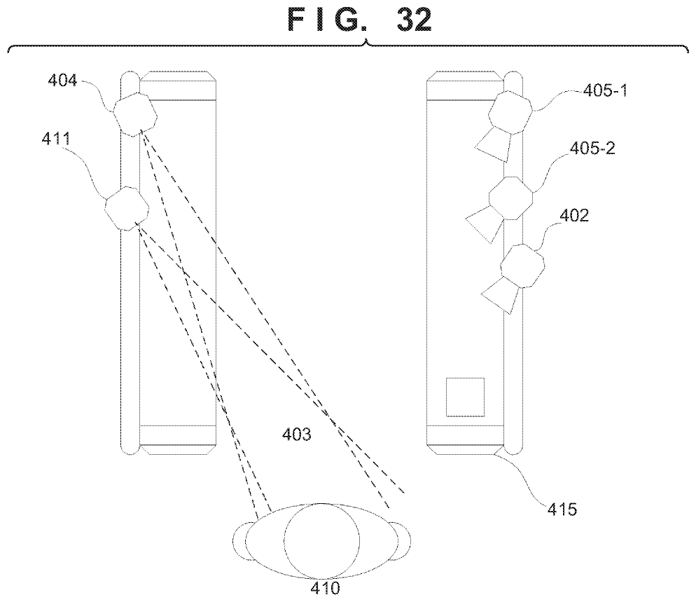

This embodiment will be described with reference to FIG. 30. Based on the inspection region detected from the second image, image data of a region of the first image corresponding to the inspection region is processed. The first image captured by a terahertz wave of a first wavelength generated from a first illumination source 404 is capturing 1, and the second image captured by a terahertz wave of a second wavelength generated from an illumination source 411 is capturing 2. Since the image of capturing 1 is acquired using a terahertz wave of a wavelength shorter than that in capturing 2, the resolution is high, and the information amount is large. Hence, the shape of each object held by an inspection object 410 is clear in the image acquired by the terahertz wave. However, since the terahertz wave of a short wavelength is used, the depth of field is shallow, and the capturing is sensitive to a change in the posture of the inspection object 410.

More specifically, depending on the posture of the inspection object 410, a partial shape is acquired as the shape of the object held by the inspection object 410. On the other hand, in the image obtained by capturing 2, since the wavelength of the terahertz wave is long, the resolution is low, and the shape of each object is not clear as compared to capturing 1. However, since the terahertz wave of a long wavelength is used, the depth of field is deep, and the capturing is insensitive to a change in the posture of the inspection object 410. More specifically, independently of the posture of the inspection object 410, the whole shape of the object held by the inspection object 410 is acquired. When capturing 2 of a low resolution is processed to specify the position of an object held by the inspection object 410, and the data of capturing 1 is processed based on the detected inspection region, the processing load can be reduced, and the processing can be performed at a higher speed. Hence, even if the inspection object 410 is moving, features of the inspection object 410 can be detected a plurality of times in a short moving distance during a short time, and the object under clothes can be estimated based on the detected features.

In addition, when the difference between capturing 1 and capturing 2 performed using terahertz waves of the two different wavelengths is calculated, reflection by clothes is canceled, and noise can be reduced from the obtained image information. More specifically, since scattering is the main component of reflection from whole clothes, the intensity difference is small, and the capturing is insensitive to a change in the posture of the inspection object 410 (random noise is added to the acquired image as a whole). For this reason, when the differential image between capturing 1 and capturing 2 is calculated, the signal of clothes is canceled. In addition, when the difference is calculated, an image based on the difference in the terahertz wave absorption rate of the substance through which the terahertz wave passes can be obtained. Hence, the shape of an object containing a substance other than a metal or ceramic as a component can be detected from the difference between the first image and the second image.

The object in the inspection region is estimated by a determination unit 408 by classifying the shape of the object detected from capturing 1. If the inspection object 410 moves, the shape of the object obtained from the image is often partial. Hence, the determination accuracy can be improved by accumulating a plurality of classification results and performing determination based on the accumulated classification results. In a case of a security monitoring system, a risk is determined based on the accumulation of classification results. If it is determined that the inspection object 410 holds a dangerous substance, the processing system notifies that the inspection object 410 holds a dangerous substance. When the inspection object 410 passes through a gate in which the processing system is arranged, the processing system may notify the outside of a warning. When the inspection object 410 puts in a ticket and passes through a ticket gate, the processing system may link the ticket with the inspection object 410 and set the inspection object 410 to a monitoring target.

### Sixth Embodiment

An application example of the processing system will be described with reference to FIGS. 9 and 10. FIG. 9 shows an example in which a first illumination source 404 for a terahertz wave of a first wavelength and a second illumination source 411 of a second wavelength different from the first wavelength are arranged on one side of a doorway 414 of a vehicle or the like. A first camera 402 configured to perform capturing based on the terahertz wave of the first wavelength, a second camera 405-1 configured to perform capturing based on one of visible light, infrared light, and a millimeter wave, and a second camera 405-2 configured to perform capturing based on the terahertz wave of the second wavelength are arranged on the other side of the doorway 414. When the cameras and the illumination sources are combined, the processes concerning inspection described in the first to fifth embodiments can be performed in combination.

An inspection object 410 can be tracked by the second camera 405-1, and the posture and the angle of view of the first camera 402 can be controlled. When the wavelength of the terahertz wave used for capturing by the second camera 405-2 configured to perform capturing based on a terahertz wave is set in accordance with the absorption rate of a substance, spectrum analysis can be performed. In addition, when the second cameras 405-1 and 405-2 are used to detect an inspection region, the processing load for a first image captured by the first camera 402 can be reduced.

Furthermore, the shape of an object containing a substance other than a metal or ceramic as a component can be detected using the difference in the absorption rate of the substance for the wavelength of the terahertz wave. In this embodiment, as the second cameras 405, a camera for visible light, infrared light, or a millimeter wave and a camera for a terahertz wave of a second wavelength are used. However, only one of the camera for visible light, infrared light, or a millimeter wave and the camera for a terahertz wave of a second wavelength may be used as the second camera. The illumination sources and the cameras can unnoticeably be buried in a wall surface, a ceiling, or a floor surface. The illumination sources and the cameras may be arranged on both of the left and right sides of the doorway 414. When the illumination sources and the cameras are provided near the doorway 414, situations in which a plurality of inspection objects 410 overlap can be reduced, and the inspection accuracy can be improved.

An example in which the processing system is arranged near a ticket gate machine 415 installed at a ticket gate of a station will be described with reference to FIG. 32. The first illumination source 404 for a terahertz wave of a first wavelength and the second illumination source 411 of a second wavelength different from the first wavelength are arranged on one side of the ticket gate machine 415. The first camera 402 configured to perform capturing based on the terahertz wave of the first wavelength, the second camera 405-1 configured to perform capturing based on one of visible light, infrared light, and a millimeter wave, and the second camera 405-2 configured to perform capturing based on the terahertz wave of the second wavelength are arranged on the other side of the ticket gate machine 415. When the processing system is arranged near the ticket gate machine 415, situations in which a plurality of inspection objects 410 overlap can be reduced, and the inspection accuracy can be improved.

The operation of the processing system may be started in accordance with detection of a motion of the inspection object 410 by a sensor provided separately from the processing system opening/closing of a door of a vehicle, putting of a ticket into the ticket gate machine 415, or the like. A plurality of first cameras and second cameras may be provided. By using a plurality of cameras, the detection accuracy can be improved, the number of inspection objects can be increased, and the inspection region can be expanded.

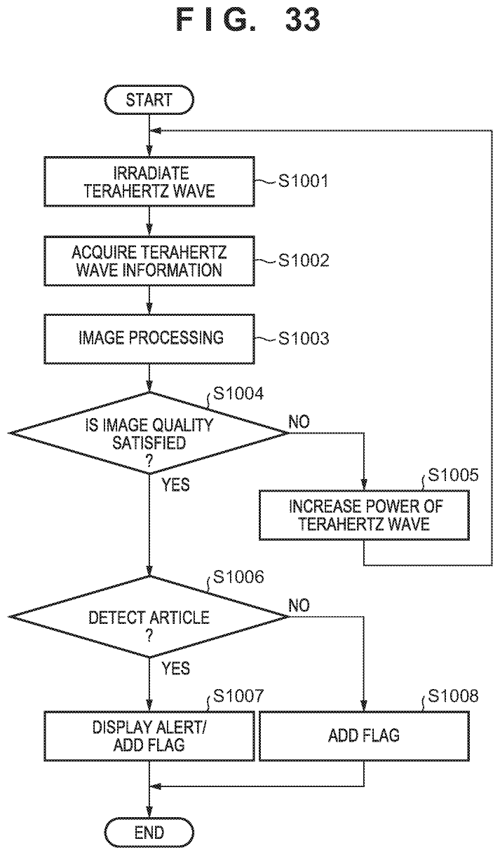

The operation of the camera system 200 will be described next with reference to FIG. 33. FIG. 33 is a flowchart showing an example of the operation of the camera system 200 according to this embodiment. As the arrangement of the camera system 200, the arrangement of the above-described embodiment can be applied. In this embodiment, an operation after an image (to be sometimes referred to as a terahertz image) based on a terahertz wave is acquired by the camera system 200 will be described. In FIG. 33, the camera system 200 evaluates the acquired image, and if the quality is less than desired quality, performs an operation of capturing an image again (recapturing).

First, in step S1001, the illumination unit 202 irradiates the inspection object 250 with a terahertz wave under a desired condition. Next, in step S1002, the camera 203 detects the terahertz wave reflected by the inspection object 250 and acquires information based on the terahertz wave. In step S1003, a control unit performs processing of converting the information based on the terahertz wave into an image. Here, the control unit can be, for example, the control system 310 as mentioned above.

Next, the control unit evaluates the quality of the acquired terahertz image (step S1004). As the evaluation items, items representing whether an appropriate terahertz image according to the inspection object 250 can be acquired, whether an article can be detected from the terahertz image of the image quality, and the like can appropriately be set. In the image quality evaluation, if desired image quality is not satisfied, the camera system 200 performs the operation of step S1005. In step S1005, the control unit supplies, to the illumination unit 202, a control signal for changing the wavelength and increasing the power of the irradiated terahertz wave. The illumination unit 202 performs terahertz wave irradiation (step S1001) again. With the series of operations, a desired article can appropriately be detected.

Note that in the image evaluation, upon determining that the desired image quality can be obtained, the control unit judges the presence and absence of a detected article, and in some cases, the type of the article (step S1006). If an article is detected, the control unit causes a monitor system to display an alert. Alternatively, the control unit outputs an instruction to perform an operation of adding a flag to an article or person of high risk (step S1007). If no article is detected, the control unit may add a flag to the confirmed person of low risk (step S1008).

For the series of operations, the illumination unit 202 and the camera 203 can be used in the following combinations. If there are the illumination unit 202 and the camera 203 used in the first capturing, second and subsequent capturing may be executed using the same illumination unit 202 and the same camera 203. In addition, if there are the illumination unit 202 and the camera 203 used in the first capturing, second and subsequent capturing may be executed using the same illumination unit 202 as in the first capturing and the camera 203 different from that in the first capturing. Furthermore, if there are the illumination unit 202 and the camera 203 used in the first capturing, second and subsequent capturing may be executed using the illumination unit 202 different from that in the first capturing and the same camera as in the first capturing. Furthermore, if there are the illumination unit 202 and the camera 203 used in the first capturing, second and subsequent capturing may be executed using the illumination unit 202 and the camera 203 which are different from those in the first capturing.

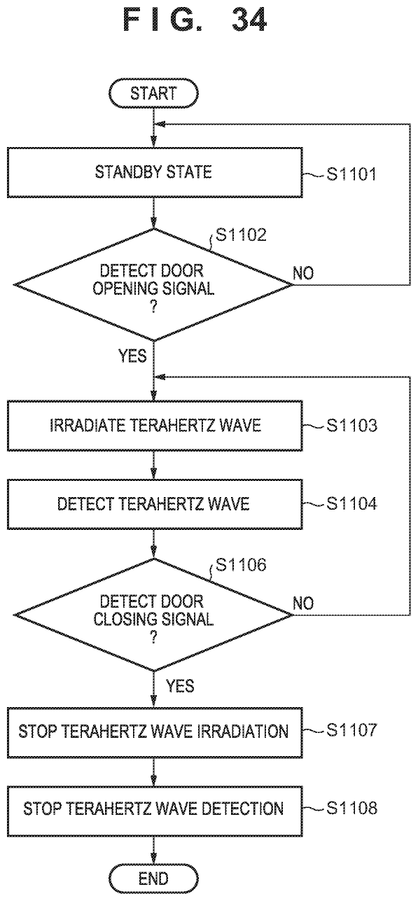

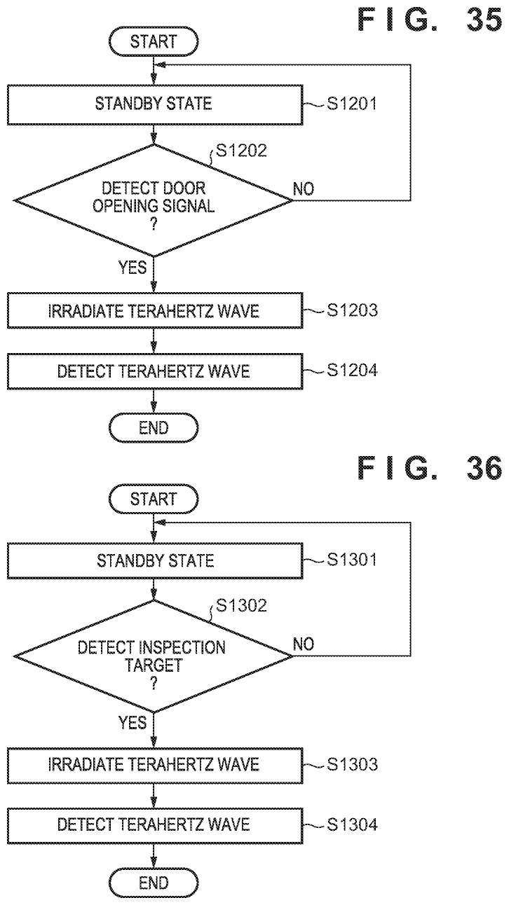

Another operation of the camera system 200 will be described next with reference to FIG. 34. In this example, an operation of capturing an image in synchronism with opening and closing of a boarding door of a railroad coach, an entrance door to a carriage, or a platform screen door will be described. FIG. 34 is a flowchart showing an operation of capturing an image in synchronism with a door. In this embodiment as well, the control unit can be, for example, the control system 310 as mentioned above A description of the same arrangements and operations as in the other embodiments will be omitted. In addition, the door can be, for example, the door 219 of the railroad coach 218 or the door portion 214 shown in FIGS. 16A to 17C.

First, in the camera system 200, the illumination unit 202 is in a standby state (step S1101). At this time, the camera 203 may also be in the standby state. The control unit detects a door opening signal (step S1102). Upon detecting the door opening signal, the control unit supplies a control signal for irradiating the inspection object 250 to the illumination unit 202, and supplies a control signal for capturing the inspection object 250 to the camera 203. The illumination unit 202 starts terahertz wave irradiation in accordance with the control signal from the control unit (step S1103). The camera 203 starts detecting the terahertz wave in accordance with the start of illumination by the illumination unit 202 (step S1104). If the control unit does not detect the door opening signal, the standby state is maintained (step S1101). Upon detecting the door opening signal in step S1102, the control unit is set in a state in which it can always detect the door closing signal (step S1106). Upon detecting a door closing signal in step S1106, the control unit supplies a control signal for stopping terahertz wave irradiation to the illumination unit 202, and supplies a control signal for stopping terahertz wave detection to the camera 203 (steps S1107 and S1108). Here, if the control unit detects the door closing signal, at least one of steps S1107 and S1108 is performed. If the door closing signal is not detected, irradiation and detection of the terahertz wave are continued, and the camera system 200 continues capturing. By the series of operations of monitoring the open and close state of the door, power of the camera system 200 can be saved. In addition, by the series of operations, reliable capturing can be performed at a necessary timing

Still another operation of the camera system 200 will be described next with reference to FIG. 34. In this example, a case in which an image is captured in synchronism with the operation of the ticket gate machine 211 will be described. FIG. 34 is a flowchart showing an operation of capturing an image in synchronism with the ticket gate machine 211. In this embodiment as well, the control unit can be, for example, the control system 310 as mentioned above. A description of the same arrangements and operations as in the other embodiments will be omitted.

First, in the camera system 200, the illumination unit 202 is in a standby state (step S1201). At this time, the camera may also be in the standby state. The control unit is in a state in which it can detect a door opening signal that notifies that the door provided in the ticket gate machine 211 opens (step S1202). If the control unit detects the door opening signal, the illumination unit 202 starts terahertz wave irradiation (step S1203). In addition, the camera 203 starts detecting the terahertz wave in accordance with the start of illumination by the illumination unit 202 (step S1204). If the control unit does not detect the door opening signal, the standby state is maintained (step S1201). To detect the door opening signal in step S1202, a signal generated by a ticket put into the ticket gate machine 211, a signal generated by bringing a ticket such as an IC card into contact with the ticket gate machine 211, or a signal for detecting the presence and absence of a ticket such as an IC card using a millimeter wave in the ticket gate machine 211 can be used. When the open and close state of the door of the ticket gate machine 211 is monitored in this way, power can be saved. In addition, by the operation, reliable capturing can be performed.

Still another operation of the camera system 200 will be described next with reference to FIG. 36. In this embodiment, an operation performed in a case in which the sensor 260 described with reference to FIG. 14B is used will be described. FIG. 36 is a flowchart showing the capturing operation in the ticket gate machine 211. In this embodiment as well, the control unit can be, for example, the control system 310 as mentioned above. A description of the same arrangements and operations as in the other embodiments will be omitted.

As described above, the sensor 260 detects the inspection object 250. Here, the sensor 260 may be, for example, a motion sensor using infrared rays or a camera using visible light. First, in the camera system 200, the illumination unit 202 is in a standby state (step S1301). At this time, the camera may also be in the standby state. Next, the inspection object 250 is detected using the sensor 260 (step S1302). The signal from the sensor 260 is sent to the control unit. Upon determining that the inspection object 250 is detected, the control unit supplies a control signal for irradiating the inspection object 250 to the illumination unit 202. The illumination unit 202 starts terahertz wave irradiation in accordance with the control signal from the control unit (step S1303). In addition, the control unit supplies a control signal for capturing the inspection object 250 to the camera 203. The camera 203 starts detecting the terahertz wave in accordance with the control signal from the control unit (step S1304). If the control unit does not determine that the inspection object 250 is detected, the standby state is maintained (step S1301).

By this operation, power can be saved. Additionally, with this operation, reliably capturing can be performed. In this embodiment, a case in which the inspection object 250 is a person has been described. However, the inspection object 250 may be an object. This arrangement can also be applied to the escalator 221 shown in FIGS. 18A and 18B, or the like. If the escalator includes a motion sensor, the sensor can be shared.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-047787, filed Mar. 14, 2019 and Japanese Patent Application No. 2020-032189, filed Feb. 27, 2020, which are hereby incorporated by reference herein in their entirety.

What is claimed is:

1. A movable body comprising an imaging system configured to acquire an image formed by a terahertz wave, wherein the image is an image obtained by capturing an inspection object inside the movable body.

2. The movable body according to claim 1, wherein the imaging system is arranged to capture the inspection object using a common-use portion of the movable body.

3. The movable body according to claim 2, wherein the common-use portion includes an aisle, and the imaging system includes a camera configured to capture the inspection object using the aisle.

4. The movable body according to claim 3, wherein the aisle includes a deck, and the imaging system includes the camera configured to capture the inspection object using the deck.

5. The movable body according to claim 3, wherein the aisle includes a cabin aisle that passes by a side of a space where a seat is arranged, and the imaging system includes the camera configured to capture the inspection object using the cabin aisle.

6. The movable body according to claim 5, wherein the camera is arranged on the seat.

7. The movable body according to claim 3, wherein the camera is arranged on a rack.

8. The movable body according to claim 3, wherein the aisle includes a first aisle extending in a first direction, and a second aisle extending in a second direction different from the first direction and connected to the first aisle, and
the imaging system includes the camera configured to capture the inspection object passing through a connecting portion between the first aisle and the second aisle.

9. The movable body according to claim 3, wherein the aisle includes a first aisle extending in a first direction, and a second aisle extending in a second direction different from the first direction and connected to the first aisle, and
the imaging system includes a plurality of cameras configured to capture the inspection object passing through a connecting portion between the first aisle and the second aisle, and optical axes of the plurality of cameras face directions different from each other.

10. The movable body according to claim 8, wherein the first aisle and the second aisle intersect at the connecting portion.

11. The movable body according to claim 3, wherein the aisle includes a staircase, and
the imaging system includes the camera configured to capture the inspection object passing through the staircase.

12. The movable body according to claim 3, wherein the common-use portion includes a wash stand, and the imaging system includes the camera configured to capture the inspection object using the aisle.

13. The movable body according to claim 3, wherein the common-use portion includes a rest room, and the imaging system captures the inspection object using the rest room.

14. The movable body according to claim 3, wherein the imaging system includes an illumination source configured to radiate the terahertz wave.

15. The movable body according to claim 3, wherein the imaging system includes a plurality of illumination sources configured to irradiate the inspection object using the aisle with the terahertz wave, and a plurality of cameras configured to capture the inspection object irradiated with the terahertz wave.

16. The movable body according to claim 15, wherein each of the plurality of illumination sources is embedded in one of a ceiling and a floor of the movable body, and each of the plurality of cameras is embedded in one of the ceiling and the floor.

17. The movable body according to claim 3, wherein the common-use portion includes a first aisle extending in a first direction, and a second aisle extending in a second direction different from the first direction and connected to the first aisle, and
the imaging system includes a plurality of illumination sources configured to irradiate the inspection object passing through a connecting portion between the first aisle and the second aisle with the terahertz wave, and a plurality of cameras configured to capture the inspection object irradiated with the terahertz wave.

18. The movable body according to claim 17, wherein a wall facing the connecting portion includes a curved surface configured to reflect the terahertz wave.

19. The movable body according to claim 17, wherein the plurality of illumination sources and the plurality of cameras are embedded in a wall facing the connecting portion.

20. The movable body according to claim 2, wherein the imaging system includes a plurality of illumination sources arranged on a seat to irradiate the inspection object using the common-use portion with the terahertz wave, and a camera configured to capture the inspection object irradiated with the terahertz wave.

21. The movable body according to claim 20, wherein the plurality of illumination sources include at least two illumination sources arranged on a backrest of the seat.

22. The movable body according to claim 20, wherein the camera is arranged on one of a ceiling and a floor of the movable body.

23. The movable body according to claim 2, wherein the common-use portion includes an aisle arranged between a first seat row formed by a plurality of first seats and a second seat row formed by a plurality of second seats,
the imaging system includes a plurality of illumination sources configured to irradiate the inspection object using the aisle with the terahertz wave, and a plurality of cameras configured to capture the inspection object irradiated with the terahertz wave,
some of the plurality of illumination sources and some of the plurality of cameras are alternately arranged in the first seat row, and
a rest of the plurality of illumination sources and a rest of the plurality of cameras are alternately arranged in the second seat row.

24. The movable body according to claim 2, wherein the imaging system includes a plurality of illumination sources arranged on a plurality of seats to irradiate the inspection object using the common-use portion with the terahertz wave, and a camera arranged on a periphery of a doorway of a cabin to capture the inspection object irradiated with the terahertz wave.

25. The movable body according to claim 24, further comprising a sensor configured to detect the inspection object,
wherein the plurality of illumination sources are controlled based on an output of the sensor.

26. The movable body according to claim 14, wherein the imaging system includes a reflecting surface configured to reflect the terahertz wave, and the reflecting surface includes a curved surface.

27. The movable body according to claim 2, further comprising a processor configured to perform processing of a signal output from the imaging system,
wherein the processing includes deciding a risk concerning the inspection object.

28. The movable body according to claim 27, wherein the processing includes specifying a position of the inspection object having a predetermined risk.

29. The movable body according to claim 27, wherein the processing includes specifying a seat of the inspection object having a predetermined risk.

30. The movable body according to claim 29, wherein the processor specifies the seat of the inspection object based on correspondence information that associates feature information of the inspection object with seat information assigned to a passenger having a feature corresponding to the feature information.

31. The movable body according to claim 30, wherein the feature information is information extracted from an image captured by the imaging system.

32. The movable body according to claim 27, wherein the processor transmits a result of the processing to a terminal set in advance.

33. The movable body according to claim 1, wherein the imaging system is arranged at a position where the inspection object moving in the movable body is rectified.

34. The movable body according to claim 1, wherein the imaging system is arranged at a position where the inspection object moving in the movable body makes a direction change.

35. The movable body according to claim 1, wherein the imaging system is arranged at a position where the inspection object moving in the movable body decelerates or stops.

36. The movable body according to claim 1, wherein the imaging system is arranged at a position where the inspection object moving in the movable body rotates.
